(19) United States
(12) Patent Application Publication
(10) Pub. No.: US 2006/0287450 A1
(43) Pub. Date: Dec. 21, 2006

(54) Immobilizable ruthenium catalysts having n-heterocyclic carbene ligands

(76) Inventors: Katrin Kohler, Gottingen (DE); Kerstin Weigl, Bad Salzungen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/567,846

(22) PCT Filed: Jul. 14, 2004
(86) PCT No.: PCT/EP04/07775

§ 371 Date: Feb. 10, 2006

(30) Foreign Application Priority Data
Aug. 11, 2003 (DE) 103 37 119.2

(51) Int. Cl. C08F 4/44; C07F 15/00

(52) U.S. Cl. 526/176; 548/101

(57) ABSTRACT

The invention relates to immobilisable ruthenium catalysts containing N-heterocyclic carbene ligands of the general formulae (I) and (II) 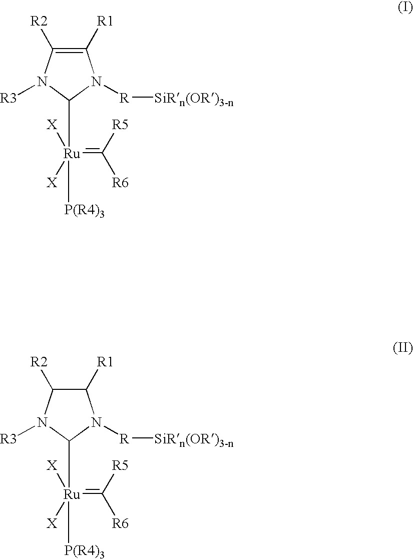
which contain an SiR′ₙ(OR′)₃ -carrying group on one of the two nitrogen atoms of the NHC ligand, and to the use thereof as homogeneous catalysts in C-C coupling reactions, in particular olefin metathesis. The invention furthermore relates to the use of the compounds as starting materials for the preparation of analogous immobilised ruthenium catalysts containing N-heterocyclic carbene ligands.

The invention relates to immobilisable ruthenium catalysts containing N-heterocyclic carbene ligands of the general formulae (I) and (II) 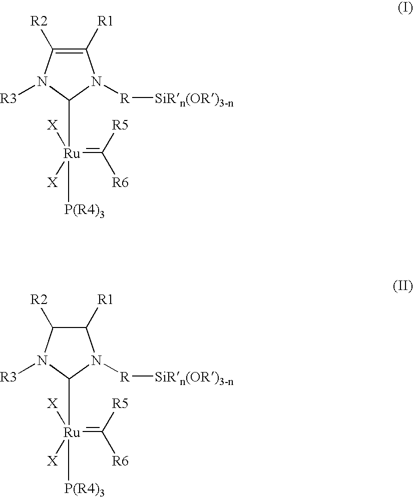
which contain an SiR′ₙ(OR′)₃₋ₙ-carrying group on one of the two nitrogen atoms of the NHC ligand, and to the use thereof as homogeneous catalysts in C-C coupling reactions, in particular olefin metathesis. The invention furthermore relates to the use of the compounds as starting materials for the preparation of analogous immobilised ruthenium catalysts containing N-heterocyclic carbene ligands.

### PRIOR ART AND OBJECT OF THE INVENTION

Examples of ruthenium catalysts containing N-heterocyclic carbene ligands are described, for example, in WO 00/15339, WO 00/71554, WO 99/51344, EP 0721953 and, for example, in Chem. Eur. J. 2001, 7, 3236; J. Am. Chem. Soc. 1999, 121, 2674; Organic Letters 1999, 1(6), 953 and in J. Organomet. Chem. 2000, 606, 49. In the compounds described, the substituents on the two nitrogen atoms consist of pure hydrocarbon radicals which are not capable of immobilisation of the ruthenium catalyst on a support; they are employed as homogeneous catalysts. Since the separation of homogeneous catalysts from the reaction products is an expensive and complex procedure, it is of major advantage to employ homogeneous catalysts immobilised on a support in catalytic processes. These immobilised catalysts can be separated off from the reaction products very simply by filtration. This is of major interest, in particular, if the catalyst is very expensive and is thus to be recycled and re-employed in the next catalytic process or if the reaction products of the catalytic process must not be contaminated with transition metals, as are present in the complex compounds. This applies in particular to products for pharmaceutical applications. Immobilisation of ruthenium catalysts containing N-heterocyclic ligands on organic supports, such as polystyrene, is described in Angew. Chem. 2000, 112, 4062. However, organic support materials have many disadvantages compared with very robust inorganic support materials, such as considerable swelling or shrinkage depending on the media used, which can reduce the catalyst activity in an unforseeable manner. Immobilisation of these catalysts on inorganic oxides has been described by Buchmeiser et al. in Angew. Chem. 2000, 112, 4062, Designed Monomers and Polymers 2002, 5(2,3), 325 and in Adv. Synth. Catal. 2002, 344, 712. The immobilisation method is very complex, and the catalyst is separated from the inorganic oxide by an organic copolymer, i.e. it is ultimately immobilised on an organic support. Hoveyda et al. in Angew. Chem. 2001, 113, 4381, report on the immobilisation of a ruthenium catalyst containing an N-heterocyclic carbene ligand on an oxide material with a smaller linker. However, the catalyst is anchored here via the benzylidene ligand. During the catalytic metathesis reaction, however, the bond between the benzylidene ligand and the ruthenium centre is broken, causing the catalyst to be detached from the support and to be transferred into the reaction solution. This results in considerable loss of catalyst on the support (considerable catalyst leaching), which makes re-use with adequate conversions impossible.

The object of the present invention was to make ruthenium catalysts containing N-heterocyclic carbene ligands which can be immobilised on inorganic oxides accessible. It should be possible to prepare these compounds in a simple manner, covalently bond them to an inorganic support and make them available for application reactions in sufficiently large amount on the support surface. It should be possible for them to be firmly anchored to the surface, and they should exhibit no catalyst leaching.

### DESCRIPTION OF THE INVENTION

The object is achieved by compounds of the general formulae (I) and (II) 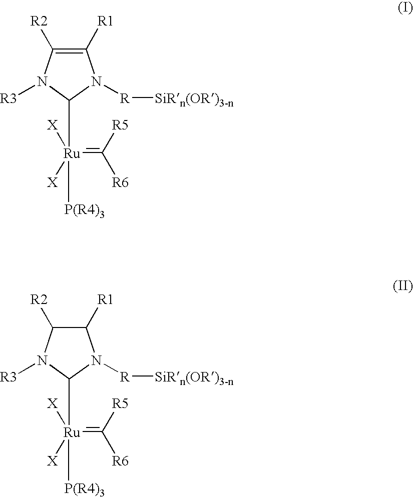
in which
R is A, Ar, A-Ar, A-Ar-A, Het, AHet or AHetA having a total of not more than 30 carbon atoms, where
A is a straight-chain, branched or saturated C₁—C₂₀-alkyl radical, cycloalkyl or cycloalkyl bonded via one or two alkyl group(s) having a total of 4 -30 carbon atoms, where one CH₂ or CH group both in the alkyl radical and in the cycloalkyl radical may be replaced by N, NH, NA, O and/or S and H atoms may be replaced by OA, NA₂ and/or PA₂,
Ar is mono- or polysubstituted or unsubstituted phenyl, naphthyl, anthryl or phenanthryl having a total of not more than 20 carbon atoms, where substituents may be A, Hal, OA, NA₂, PA₂, COOA, COA, CN, CONHA, NO₂, =NH or =O,
Het is a monocyclic or bicyclic, saturated or unsaturated or aromatic heterocyclic radical having from 1 to 4 N, O and/or S atoms, which may be unsubstituted or mono-, di- or trisubstituted by Hal and/or A, OA, COOA, COA, CN, CONHA, NA₂, PA₂, NO₂, =NH or =O, where
Hal is F, Cl, Br or l,
R′, independently of the position in the molecule, is A or Ar having 1-12 carbon atoms,
R3 is A, Ar, AAr, AArA, Het, AHet or AHetA having 6-18 carbon atoms, in which the radical A which is not bonded to Ar or Het is an alkyl or cycloalkyl which is unsubstituted or substituted by one or more groups Z, and Ar is an aromatic hydrocarbon which is unsubstituted or monoor polysubstituted by a group Z, and Het is a saturated, unsaturated or aromatic heterocyclic radical, which may be mono- or polysubstituted by a group Z, and
R1 and R2, independently of one another, are H, Z, Hal or A, Ar, Mr, Het or AHet having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z,
R4 is A, Ar or AAr having 1-30 carbon atoms,
R5 and R6, independently of one another, are H, A or Ar, where H atoms in A or Ar may be substituted by alkenyl or alkynyl radicals, having not more than 30 carbon atoms, where
Hal is F, Cl, Br or l,
Z, independently of the position in R1, R2 and R3, are functional groups containing N, P, O or S atoms, or A or Ar, and
X are anionic ligands which are identical to or different from one another and which each form a ligand bond to Ru, and
n is0,1 or2.

The present invention furthermore also relates to compounds of the general formulae (I) and (II) in which R, R′, R1, R2, R3, R4, R5 and R6 as well as Z, X and n are as defined in claims 2 to 6.

In particular, the object of the present invention is achieved by compounds of the general formulae (I) and (II) with the meaning

{1-[3-(triethoxysilyl)ethyl]-3-[2,4-(di-i-propyl)phenyl]imidazol-2-ylidene}-[P(Cy)₃]Cl₂Ru=CHPh

{1-[3-(trimethoxysilyl)ethyl]-3-[2,4-(di-i-propyl)phenyl]imidazol-2-ylidene}-[P(Cy)₃]Cl₂Ru=CHPh

{1-[3-(triethoxysilyl)propyl]-3-[2,4-(di-i-propyl)phenyl]imidazol-2-ylidene)-}-[P(Cy)₃]Cl₂Ru=CHPh

{1-[3-(trimethoxysilyl)propyl]-3-[2,4-(di-i-propyl)phenyl]imidazol-2-ylidene)-}-[P(Cy)₃]Cl₂Ru=CHPh

{1-[3-(triethoxysilyl)butyl]-3-[2 ,4-(di-i-propyl)phenyl]imidazol-2-ylidene}-[P(Cy)₃]Cl₂Ru=CHPh

{1-[3-(trimethoxysilyl)butyl]-3-[2,4-(di-i-propyl)phenyl]imidazol-2-ylidene}-[P(Cy)₃]Cl₂Ru=CHPh

{1-[3-(triethoxysilyl)ethyl]-3-(mesityl)imidazol-2-ylidene}[P(Cy)₃]Cl₂Ru=CHPh

{1-[3-(trimethoxysilyl)ethyl]-3-(mesityl)imidazol-2-ylidene)}[P(CY)₃]Cl₂Ru=CHPh

{1-[3-(triethoxysilyl)propyl]-3-(mesityl)imidazol-2-ylidene}[P(Cy)₃]Cl₂Ru=CHPh

{1-[3-(trimethoxysilyl)propyl]-3-(mesityl)imidazol-2-ylidene}[P(CY)₃]Cl₂Ru=CHPh

{1-[3-(triethoxysilyl)butyl]-3-(mesityl)imidazol-2-ylidene}[P(CY)₃]Cl₂Ru=CHPh

{1-[3-(trimethoxysilyl)butyl]-3-(mesityl)imidazol-2-ylidene}[P(CY)₃]Cl₂Ru=CHPh

{1-[3-(triethoxysilyl)ethyl]-3-(phenyl)imidazol-2-ylidene}[P(Cy)₃]Cl₂Ru=CHPh

{1-[3-(trimethoxysilyl)ethyl]-3-(phenyl)imidazol-2-ylidene}[P(CY)₃]Cl₂Ru=CHPh

{1-[3-(triethoxysilyl)propyl]-3-(phenyl)imidazol-2-ylidene}[P(Cy)₃]Cl₂Ru=CHPh

{1-[3-(trimethoxysilyl)propyl]-3-(phenyl)imidazol-2-ylidene}[P(CY)₃]Cl₂Ru =CHPh

{1-[3-(triethoxysilyl)butyl]-3-(phenyl)imidazol-2-ylidene)}[P(CY)₃]Cl₂Ru=CHPh

{1-[3-(trimethoxysilyl)butyl]-3-(phenyl)imidazol-2-ylidene}[P(CY)₃]Cl₂Ru=CHPh

{1-[3-(triethoxysilyl)ethyl]-3-(cyclohexyl)imidazol-2-ylidene}[P(Cy)₃]Cl₂Ru=CHPh

{1-[3-(trimethoxysilyl)ethyl]-3-(cyclohexyl)imidazol-2-ylidene}-[P(Cy)₃]Cl₂Ru=CHPh

{1-[3-(triethoxysilyl)propyl]-3-(cyclohexyl)imidazol-2-ylidene}-[P(Cy)₃]Cl₂Ru=CHPh

{1-[3-(trimethoxysilyl)propyl]-3-(cyclohexyl)imidazol-2-ylidene}-[P(Cy)₃]Cl₂Ru=CHPh

{1-[3-(triethoxysilyl)butyl]-3-(cyclohexyl)imidazol-2-ylidene}[P(Cy)₃]Cl₂Ru=CHPh

{1-[3-(trimethoxysilyl)butyl]-3-(cyclohexyl)imidazol-2-ylidene}-[P(Cy)₃]Cl₂Ru=CHPh

{1-[3-(triethoxysilyl)ethyl]-3-(t-butyl)imidazol-2-ylidene}[P(Cy)₃]Cl₂Ru=CHPh

{1-[3-(trimethoxysilyl)ethyl]-3-(t-butyl)imidazol-2-ylidene}[P(Cy)₃]Cl₂Ru=CHPh

{1-[3-(triethoxysilyl)propyl]-3-(t-butyl)imidazol-2-yl idene}[P(Cy)₃]Cl₂Ru =CHPh

{1-[3-(trimethoxysilyl)propyl]-3-(t-butyl)imidazol-2-ylidene}[P(Cy)₃]Cl₂Ru=CHPh

{1-[3-(triethoxysilyl)butyl]-3-(t-butyl)imidazol-2-ylidene}[P(Cy)₃]Cl₂Ru=CHPh

{1-[3-(trimethoxysilyl)butyl]-3-(t-butyl)imidazol-2-ylidene}[P(Cy)₃]Cl₂Ru=CHPh

{1-[3-(triethoxysilyl)ethyl]-3-(i-propyl)imidazol-2-ylidene)}[P(CY)hd 3]Cl₂Ru=CHPh

{1-[3-(tri methoxysilyl)ethyl]-3-(i-propyl)imidazol-2-ylidene}[P(Cy)₃]Cl₂Ru=CHPh

{1-[3-(triethoxysilyl)propyl]-3-(i-propyl)imidazol-2-ylidene}[P(CY)₃]Cl₂Ru=CHPh

{1-[3-(trimethoxysilyl)propyl]-3-(i-propyl)imidazol-2-ylidene}[P(Cy)₃]Cl₂Ru =CHPh

{1-[3-(triethoxysilyl)butyl]-3-(i-propyl)imidazol-2-ylidene}[P(CY)₃]Cl₂Ru=CHPh

{1-[3-(trimethoxysilyl)butyl]-3-(i-propyl)imidazol-2-ylidene}[P(Cy)₃]Cl₂Ru=CHPh

{1-[3-(triethoxysilyl)ethyl]-3-(methyl)imidazol-2-ylidene}[P(Cy)₃]Cl₂Ru=CHPh

{1-[3-(trimethoxysilyl)ethyl]-3-(methyl)imidazol-2-ylidene}[P(Cy)₃]Cl₂Ru=CHPh

{1-[3-(triethoxysilyl)propyl]-3-(methyl)imidazol-2-ylidene)}[P(CY)₃]Cl₂Ru=CHPh

{1-[3-(trimethoxysilyl)propyl]-3-(methyl)imidazol-2-ylidene)}[P(CY)₃]Cl₂Ru=CHPh

{1-[3-(triethoxysilyl)butyl]-3-(methyl)imidazol-2-ylidene}[P(Cy)₃]Cl₂Ru=CHPh

{1-[3-(trimethoxysilyl)butyl]-3-(methyi)imidazol-2-ylidene}[P(Cy)₃]Cl₂Ru=CHPh

{1-[4-(trimethoxysilyl)benzyl]-3-(mesityl)imidazol-2-ylidene}[P(CY)₃]Cl₂Ru=CHPh

{1-[4-(triethoxysiyl)benzyl]-3-(mesityl)imidazol-2-ylidene)}[P(CY)₃]Cl₂Ru=CHPh

{1-[4-(trimethoxysilyl)benzyl]-3-(cyclohexyl)imidazol-2-ylidene}-[P(Cy)₃]Cl₂Ru=CHPh

{1-[4-(triethoxysilyl)benzyl]-3-(cyclohexyl)imidazol-2-ylidene}-[P(Cy)₃]Cl₂Ru=CHPh

{1-[4-(trimethoxysilyl)benzyl]-3-(methyl)imidazol-2-ylidene}[P(CY)₃]Cl₂Ru=CHPh

{1-[4-(triethoxysilyl)benzyl]-3-(methyl)imidazol-2-ylidene}[P(CY)₃]Cl₂Ru=CHPh

{1-[4-(trimethoxysilyl)benzyl]-3-(phenyl)imidazol-2-ylidene}[P(Cy)₃]Cl₂Ru=CHPh

{1-[4-(triethoxysilyl)benzyl]-3-(phenyl)imidazol-2-ylidene}[P(CY)₃]Cl₂Ru=CHPh

{1-[4-(trimethoxysilyl)benzyl]-3-(i-propyl)imidazol-2-ylidene)}[P(CY)₃]Cl₂Ru=CHPh

{1-[4-(triethoxysilyl)benzyl]-3-(i-propyl)imidazol-2-ylidene}[P(Cy)₃]Cl₂Ru=CHPh

{1-[4-(trimethoxysilyl)benzyl]-3-(t-butyl)imidazol-2-ylidene}[P(Cy)₃]Cl₂Ru=CHPh

{1-[4-(triethoxysilyl)benzyl]-3-(t-butyl)imidazol-2-ylidene}[P(CY)₃]Cl₂Ru=CHPh

{1-[4-(trimethoxysilyl)benzyl]-3-[2 ,4-(di-i-propyl)phenyl]imidazol-2-ylidene}-[P(Cy)₃]Cl₂Ru=CHPh

{1-[4-(triethoxysilyl)benzyl]-3-[2,4-(di-i-propyl)phenyl]imidazol-2-ylidene}-[P(Cy)₃]Cl₂Ru=CHPh

{1-[4-(trimethoxysilyl)-2,4-(dimethyl)phenyl]-3-(mesityl)imidazol-2-ylidene}-[P(Cy)₃]Cl₂Ru=CHPh

{1-[4-(triethoxysilyl)-2,4-(dimethyi)phenyl]-3-(mesityl)imidazol-2-ylidene}-[P(Cy)₃]Cl₂Ru=CHPh

{1-[4-(trimethoxysilyl)-2,4-(dimethyl)phenyl]-3-(cyclohexyl)imidazol-2-ylidene}-[P(Cy)₃]Cl₂Ru=CHPh

{1-[4-(triethoxysilyl)-2,4-(dimethyl)phenyl]-3-(cyclohexyl)imidazol-2-ylidene}-[P(Cy)₃]Cl₂Ru=CHPh

{1-[3-(triethoxysilyl)ethyl]-3-[2,4-(di-i-propyl)phenyl]imidazolin-2-ylidene}-[P(Cy)₃]Cl₂Ru=CHPh

{1-[3-(trimethoxysilyl)ethyl]-3-[2,4-(di-i-propyl)phenyl]imidazolin-2-ylidene}-[P(CY)₃]Cl₂Ru=CHPh

{1-[3-(triethoxysilyl)propyl]-3-[2,4-(di-i-propyl)phenyl]imidazolin-2-ylidene}-35 [P(Cy)₃]Cl₂Ru=CHPh

{1-[3-(trimethoxysilyl)propyl]-3-[2,4-(di-i-propyl)phenyl]imidazolin-2-ylidene}-[P(Cy)₃]Cl₂Ru=CHPh

{1-[3-(triethoxysilyl)butyl]-3-[2,4-(di-i-propyl)phenyl]imidazolin-2-ylidene}-[P(Cy)₃]Cl₂Ru=CHPh

{1-[3-(trimethoxysilyl)butyl]-3-[2,4-(di-i-propyl)phenyl]imidazolin-2-ylidene}-[P(Cy)₃]Cl₂Ru=CHPh

{1-[3-(triethoxysilyl)ethyl]-3-(mesityl)imidazolin-2-ylidene}[P(CY)₃]Cl₂Ru=CHPh

{1-[3-(trimethoxysilyl)ethyl]-3-(mesityl)imidazolin-2-ylidene}[P(Cy)₃]Cl₂Ru=CHPh

{1-[3-(triethoxysilyl)propyl]-3-(mesityl)imidazolin-2-ylidene}[P(CY)₃]C-2Ru=CHPh

{1-[3-(trimethoxysilyl)propyl]-3-(mesityl)imidazolin-2-ylidene}-[P(Cy)₃]Cl₂Ru=CHPh

{1-[3-(triethoxysilyl)butyl]-3-(mesityl)imidazolin-2-ylidene}[P(CY)₃]Cl₂Ru=CHPh

{1-[3-(trimethoxysilyl)butyl]-3-(mesityl)imidazolin-2-ylidene}[P(Cy)₃]Cl₂Ru =CHPh

{1-[3-(triethoxysilyl)ethyl]-3-(phenyl)imidazolin-2-ylidene}[P(Cy)₃]Cl₂Ru=CHPh

{1-[3-(trimethoxysilyl)ethyl]-3-(phenyl)imidazolin-2-ylidene)}[P(CY)₃]Cl₂Ru=CHPh

{1-[3-(triethoxysilyl)propyl]-3-(phenyl)imidazolin-2-ylidene)}[P(CY)₃]Cl₂Ru=CHPh

{1-[3-(trimethoxysilyl)propyl]-3-(phenyl)imidazolin-2-ylidene}-[P(Cy)₃]Cl₂Ru=CHPh

{1-[3-(triethoxysilyl)butyl]-3-(phenyl)imidazolin-2-ylidene}[P(CY)₃]Cl₂Ru=CHPh

{1-[3-(trimethoxysilyl)butyl]-3-(phenyl)imidazolin-2-ylidene}[P(Cy)₃]Cl₂Ru=CHPh

{1-[3-(triethoxysilyl)ethyl]-3-(cyclohexyl)imidazolin-2-ylidene}-[P(Cy)₃]Cl₂Ru=CHPh

{1-[3-(tri methoxysilyl)ethyl]-3-(cyclohexyl)imidazolin-2-ylidene}-[P(Cy)₃]Cl₂Ru=CHPh

{1-[3-(triethoxysilyl)propyl]-3-(cyclohexyl)imidazolin-2-ylidene}-[P(Cy)₃]Cl₂Ru=CHPh

{1-[3-(trimethoxysilyl)propyl]-3-(cyclohexyl)imidazolin-2-ylidene}-[P(Cy)₃]Cl₂Ru=CHPh

{1-[3-(triethoxysilyl)butyl]-3-(cyclohexyl)imidazolin-2-ylidene}-[P(Cy)₃]Cl₂Ru=CHPh

{1-[3-(trimethoxysilyl)butyl]-3-(cyclohexyl)imidazolin-2-ylidene}-[P(Cy)₃]Cl₂Ru=CHPh

{1-[3-(triethoxysilyl)ethyl]-3-(t-butyl)imidazolin-2-ylidene}[P(CY)₃]Cl₂Ru=CHPh

{1-[3-(trimethoxysilyl)ethyl]-3-(t-butyl)imidazolin-2-ylidene}[P(Cy)₃]Cl₂Ru=CHPh

{1-[3-(triethoxysiyl)propyl]-3-(t-butyl)imidazolin-2-ylidene}[P(CY)₃]Cl₂Ru=CHPh

{1-[3-(trimethoxysilyl)propyl]-3-(t-butyl)imidazolin-2-ylidene}[P(Cy)₃]Cl₂Ru=CHPh

{1-[3-(triethoxysilyl)butyl]-3-(t-butyl)imidazolin-2-ylidene}[P(Cy)₃]Cl₂Ru=CHPh

{1-[3-(trimethoxysilyl)butyl]-3-(t-butyl)imidazolin-2-ylidene)}[P(CY)₃]Cl₂Ru=CHPh

{1-[3-(triethoxysilyl)ethyl]-3-(i-propyl)imidazolin-2-ylidenel}[P(CY)₃]Cl₂Ru=CHPh

{1-[3-(trimethoxysilyl)ethyl]-3-(i-propyl)imidazolin-2-ylidene}[P(CY)₃]Cl₂Ru=CHPh

{1-[3-(triethoxysilyl)propyl]-3-(i-propyl)imidazolin-2-ylidenel}[P(CY)₃]Cl₂Ru=CHPh

{1-[3-(trimethoxysilyl)propyl]-3-(i-propyl)imidazolin-2-ylidene}[P(Cy)₃]Cl₂Ru=CHPh

{1-[3-(triethoxysilyl)butyl]-3-(i-propyl)imidazolin-2-ylidene}[P(CY)₃]Cl₂Ru=CHPh

{1-[3-(trimethoxysilyl)butyl]-3-(i-propyl)imidazolin-2-ylidene}[P(CY)₃]Cl₂Ru=CHPh

{1-[3-(triethoxysilyl)ethyl]-3-(methyl)imidazolin-2-ylidene)}[P(CY)₃]Cl₂Ru=CHPh

{1-[3-(trimethoxysilyl)ethyl]-3-(methyl)imidazolin-2-ylidene}[P(Cy)₃]Cl₂Ru=CHPh

{1-[3-(triethoxysilyl)propyl]-3-(methyl)imidazolin-2-ylidene}[P(Cy)₃]Cl₂Ru=CHPh

{1-[3-(trimethoxysilyl)propyl]-3-(methyl)imidazolin-2-ylidene}-[P(Cy)₃]Cl₂Ru=CHPh

{1-[3-(triethoxysilyl)butyl]-3-(methyl)imidazolin-2-ylidene}[P(Cy)₃]Cl₂Ru=CHPh

{1-[3-(trimethoxysilyl)butyl]-3-(methyl)imidazolin-2-ylidene}[P(Cy)₃]Cl₂Ru=CHPh

{1-[4-(trimethoxysilyl)benzyl]-3-(mesityl)imidazolin-2-ylidene}-[P(Cy)₃]Cl₂Ru=CHPh

{1-[4-(triethoxysilyl)benzyl]-3-(mesityl)imidazolin-2-ylidene}[P(Cy)₃]Cl₂Ru=C H Ph

{1-[4-(trimethoxysilyl)benzyl]-3-(cyclohexyl)imidazolin-2-ylidene}-[P(Cy)₃]Cl₂Ru=CHPh

{1-[4-(triethoxysilyl)benzyl]-3-(cyclohexyl)imidazolin-2-ylidene}-[P(Cy)₃]Cl₂Ru=CHPh

{1-[4-(trimethoxysilyl)benzyl]-3-(methyl)imidazolin-2-ylidene}-[P(Cy)₃]Cl₂Ru=CHPh

{1-[4-(triethoxysilyl)benzyl]-3-(methyl)imidazolin-2-ylidene}[P(Cy)₃]Cl₂Ru=CHPh

{1-[4-(trimethoxysilyl)benzyl]-3-(phenyl)imidazolin-2-ylidene}-[P(Cy)₃]Cl₂Ru=CHPh

{1-[4-(triethoxysilyl)benzyl]-3-(phenyl)imidazolin-2-ylidene}[P(CY)₃]Cl₂Ru=CHPh

{1-[4-(trimethoxysilyl)benzyl]-3-(i-propyl)imidazolin-2-ylidene}-[P(Cy)₃]Cl₂Ru=CHPh

{1-[4-(triethoxysilyl)benzyl]-3-(i-propyl)imidazolin-2-ylidene}[P(Cy)₃]Cl₂Ru=CHPh

{1-[4-(trimethoxysilyl)benzyl]-3-(t-butyl)imidazolin-2-ylidene}-[P(Cy)₃]Cl₂Ru=CHPh

{1-[4-(triethoxysilyl)benzyl]-3-(t-butyl)imidazolin-2-ylidene}[P(Cy)₃]Cl₂Ru=CHPh

{1-[4-(trimethoxysilyl)benzyl]-3-[2,4-(di-i-propyl)phenyl]imidazolin-2-ylidene}-[P(Cy)₃]Cl₂Ru=CHPh

{1-[4-(triethoxysilyl)benzyl]-3-[2,4-(di-i-propyl)phenyl]imidazolin-2-ylidene}-[P(Cy)₃]Cl₂Ru=CHPh

{1-[4-(trimethoxysilyl)-2,4-(dimethyl)phenyl]-3-(mesityl)imidazolin-2-ylidene}-[P(Cy)₃]Cl₂Ru=CHPh

{1-[4-(triethoxysilyl)-2,4-(dimethyl)phenyl]-3-(mesityl)imidazolin-2-ylidene}-[P(Cy)₃]Cl₂Ru=CHPh

{1-[4-(trimethoxysilyl)-2,4-(dimethyl)phenyl]-3-(cyclohexyl)imidazolin-2-ylidene}-[P(Cy)₃]Cl₂Ru=CHPh

{1-[4-(triethoxysilyl)-2,4-(dimethyl)phenyl]-3-(cyclohexyl)imidazolin-2-ylidene)}-[P(Cy)₃]Cl₂Ru=CHPh.

Further examples are all compounds mentioned here containing a PPh₃ group instead of the P(Cy)₃ group. Of these, further examples are in turn all compounds containing 2 Br ligands instead of the 2 Cl ligands. Of these, further examples are in turn all compounds containing =C(H)C=CMe₂ instead of =CHPh.

In particular, the present invention relates to a process for the preparation of compounds of the general formulae (I) and (II) in which an alkoxysilyl-functionalised imidazolium salt of the general formula (Ill) 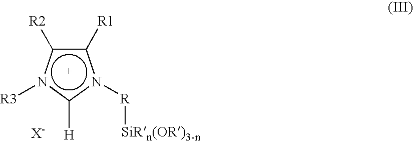
or an alkoxysilyl-functionalised 4,5-dihydroimidazolium salt of the general formula (IV) 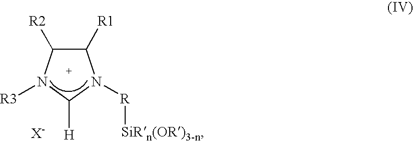
in which R, R′, R1, R2 and R3 may adopt the meanings given in the preceding claims, and X⁻ can be an anion from the group consisting of F⁻, Cl⁻, Br⁻ and I⁻, is either converted directly into a compound of the general formula (I) or (II) respectively 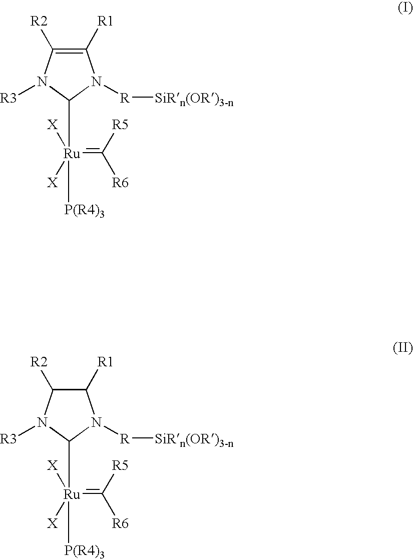
by reacting the compounds of the general formula (Ill) or (IV) with a base capable of deprotonation selected from the group consisting of the metal alkoxides (MOR), metal hydrides (MH), metal amides (MNH₂) and/or ammonia in the presence of a compound of the general formula (X)
[P(R4)₃]₂X₂Ru=CR5R6 (X),
in which R4, R5, R6 and X are as defined above, in an anhydrous, inert, aprotic, organic solvent, or in which the compounds of the general formula (Ill) or (IV), if necessary after prior purification, are reacted with a base selected from the group consisting of the metal alkoxides (MOR), metal hydrides (MH), metal amides (MNH₂) and/or ammonia in an anhydrous, inert, aprotic, organic solvent to give carbenes of the general formula (V) or (VI) respectively 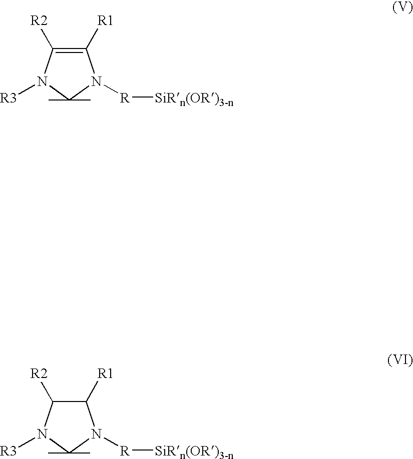
and are subsequently reacted with compounds of the general formula (X)
[P(R4)₃]₂X₂Ru=CR5R6 (X)
in an anhydrous, inert, aprotic, organic solvent under a protective-gas atmosphere to give compounds of the general formula (I) or (II) respectively.

The compounds of the general formulae (Ill) and (IV), the base employed and the ruthenium compound of the general formula (X) are employed in this process in a stoichiometric ratio in the range from 1:1:1 to 1:1.5:1.5, where the ratio of the base employed to the ruthenium compound is independent of one another.

For the conversion of the compounds of the general formulae (Ill) and (IV) into ruthenium compounds of the general formulae (I) and (II) respectively, the base employed is preferably potassium t-butoxide KO^{t}butoxide or potassium hydride KH. The solvents used for this reaction can, in accordance with the invention, be hydrocarbons or ethers. For this, a solvent selected from the group consisting of pentane, hexane, heptane, octane, decane, benzene, toluene and tetrahydrofuran or mixtures thereof is preferably used. In accordance with the invention, the reaction of the compounds of the general formulae (Ill) and (IV) with a ruthenium compound of the general formula (X) is carried out over the course of from 30 minutes to two days at a temperature in the range from −78 to +150° C., where the protective gas used is nitrogen or argon.

The alternative process according to the invention for the preparation of the ruthenium compounds of the general formulae (I) and (II) from carbenes of the general formulae (V) and (VI) respectively is usually carried out in a solvent selected from the group consisting of pentane, hexane, heptane, octane, decane, benzene, toluene and tetrahydrofuran, with the carbenes of the general formulae (V) and (VI) being employed in a stoichiometric ratio to the ruthenium compounds of the general formula (X) in the range between 1:1 and 1:1.5, and the reaction being carried out over the course of from 30 minutes to two days at a temperature in the range from −78 to +100° C.

The present invention also relates to the use of the compounds of the general formulae (I) and (II) as catalysts in organic and organometallic synthesis. In accordance with the invention, the compounds of the general formulae (I) and (II) can be used as starting materials for the preparation of immobilised catalysts for organic and organometallic syntheses. In particular, the compounds of the general formulae (I) and (II) can be employed as catalysts in C-C coupling reactions, hydrogenations, isomerisations, silylations and hydroformylations or as catalysts in olefin metathesis reactions, such as cross metathesis (CM), ring closure metathesis (RCM), ring opening metathesis polymerisation (ROMP), acyclic diene metathesis polymerisation (ADMET) and ene-yne metathesis.

### DETAILED DESCRIPTION OF THE INVENTION

Compounds of the general formulae (I) and (II) according to the invention are ruthenium compounds in which the ruthenium atom is in oxidation state 2 and to which a neutral N-heterocyclic carbene ligand, a neutral phosphine ligand, a neutral alkylidene ligand and two singly charged anions are bonded as ligands. N-heterocyclic carbene ligands are 1,3-disubstituted imidazol-2-ylidenes and 1,3-disubstituted imidazolin-2-ylidenes derived from imidazole or 4,5-dihydroimidazole as parent structures. In both types of ligand, the carbon atom between the two nitrogen atoms of the heterocyclic radical is a carbene carbon atom which is coordinatively bonded to the ruthenium atom by means of the free electron pair. The alkylidene ligand also contains a carbene carbon atom which is bonded to the ruthenium centre. An R-SiR′ₙ(OR′)ₙ₋₃ group is bonded to at least one of the two nitrogen atoms of the NHC ligand, where the Si(OR′)₃₋ₙ unit is capable of a subsequent reaction with a metal oxide having active OH groups on the surface.

The compounds of the general formulae (I) and (II) can basically be prepared by two different methods, which are referred to below as method A and method B.

The preparation of the compounds of the general formulae (I) and (II) can be carried out by method A by reaction of compounds of the general formulae (Ill) and (IV) respectively in accordance with reaction equations Eq. 1 and Eq. 2 respectively with a base which is capable of deprotonation of (I) and (II) respectively, such as, for example, metal alkoxides, MOR, metal hydrides, MH, metal amides MNH₂ or ammonia, and [P(R4)₃]₂X₂Ru=CR5R6 in anhydrous, inert, aprotic, organic solvents. After the by-products have been separated off, the compounds of the general formulae (I) and (II) can be obtained. 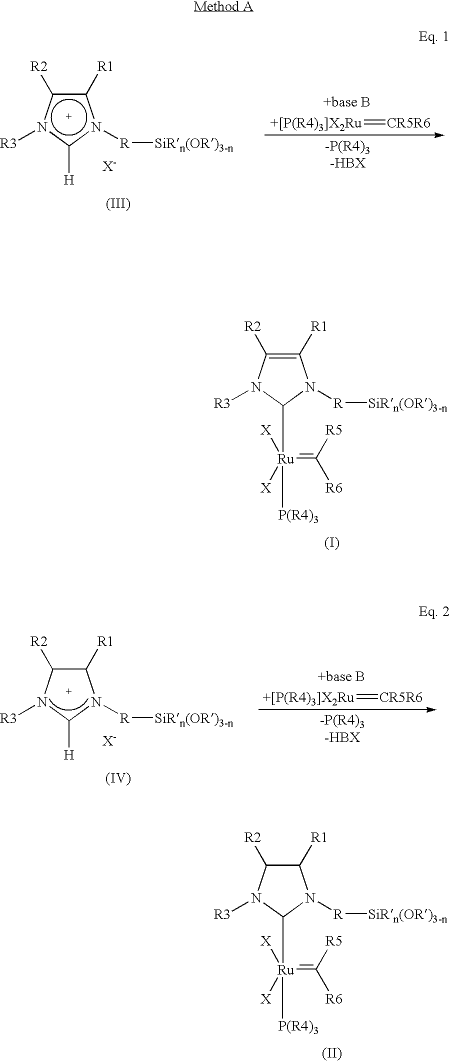
The preparation of the compounds of the general formulae (I) and (II) can also be carried out by method B by reaction of compounds of the general formulae (V) and (VI) respectively analogously to reaction equations Eq. 3 and Eq. 4 respectively with [P(R4)₃]₂X₂Ru=CR5R6 in anhydrous, inert, aprotic, organic solvents. After the by-products have been separated off, the compounds of the general formulae (I) and (II) can be obtained.

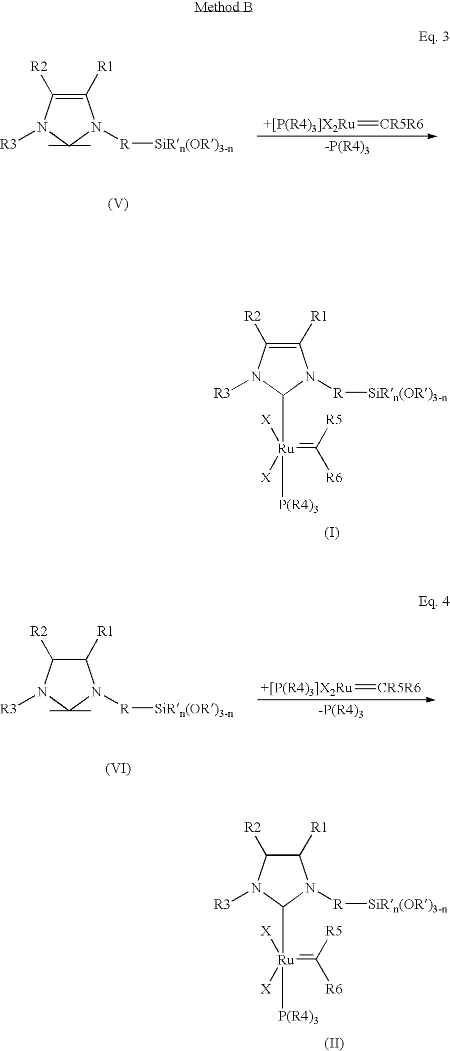

In the case of method B, the reaction is also carried out under a protective-gas atmosphere. Here too, nitrogen and argon are preferred as protective gases. In order to carry out the reaction, the starting materials can be dissolved or suspended in anhydrous, inert, aprotic, organic solvents.

The compounds of the general formulae (I) and (II) can be used as catalysts in organic and organometallic synthesis. They furthermore serve as starting materials for the preparation of immobilised catalysts, which can in turn be employed in organic and organometallic synthesis. In particular, they can be used as catalysts in C-C coupling reactions, hydrogenations and hydroformylation.

The advantages of the compounds of the general formulae (I) and (II) compared with the prior art are: the compounds can be immobilised covalently on a support through the SiR′ₙ(OR′)₃-n group present. They can thus be separatedoff very simply from the reaction solutions or reaction products in application reactions. The compounds of the general formulae (I) and (II) can thus be recycled and re-employed as catalyst in catalytic reactions. This results in a saving of process costs in all application reactions, in particular in catalytic reactions using expensive transition-metal catalysts. Since the SiR′ₙ(OR′)₃- ngroup capable of immobilisation is bonded to the N-heterocyclic carbene ligand, and the latter is bonded more strongly to the ruthenium atom than is the P(R4)₃ group, it is ensured that immobilised ruthenium catalysts which have no catalyst leaching are accessible for the first time. During the catalytic reaction, the relatively weakly bonded phosphine ligand dissociates from the catalytically active ruthenium centre into the solution, so that the catalytically active species remains bonded to the support throughout the catalysis and catalyst loss due to leaching thus cannot occur. The compounds of the general formulae (I) and (II) are accessible very simply and in quantitative yields.

R′ in the SiR′ₙ(OR′)_{3-N} unit is a hydrocarbon radical, where n can be 0,1 or 2, preferably 0 or 1 and very preferably 0. This hydrocarbon radical R′ can adopt different meanings independently of the position in the molecule and can be straight-chain, unbranched (linear), branched, saturated, mono- or polyunsaturated, cyclic (A), aromatic (Ar) or alkylaromatic (AAr or AArA), and optionally mono- or polysubstituted. A and Ar can adopt all the meanings given below.

R′ is preferably a straight-chain, unbranched (linear), branched, saturated, mono- or polyunsaturated or cyclic saturated or mono- or polyunsaturated alkyl radical having 1-12 carbon atoms. R′ is particularly preferably a straight-chain or branched saturated alkyl radical having 1-7 carbon atoms, i.e. a sub-group of the alkyl group A, which is defined in greater detail below.

R′ can thus preferably adopt the meanings methyl, ethyl, propyl, i-propyl, butyl, i-butyl, sec-butyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methylpropyl (—C₆H₁₂—), 1-ethyl-2-methylpropyl (—C₆H₁₂—), 1,1,2- or 1,2,2-trimethylpropyl (—C₆H₁₂—), heptyl, octyl, nonyl, decyl, undecyl or dodecyl.

R′ is very particularly preferably a C₁—C₄-alkyl radical from the group consisting of methyl, ethyl, propyl, i-propyl, butyl, i-butyl, sec-butyl and tert-butyl.

In SiR′ₙ(OR′)ₙ₋₃, R′ can, however, alternatively be

alkenyl vinyl, propenyl, 1,2-propadienyl, butenyl, butadienyl, pentenyl, 1,2-, 1,4- or1,3-pentadienyl, 2,3-dimethyl-2-butenyl, hexenyl, 1,5-hexadienyl, 2-methyl-1,3-butadienyl, 2,3-dimethyl-1,3-butadienyl or isopentenyl,

cycloalkenyl cyclopropenyl, cyclobutenyl, cyclopentenyl, cyclopentadienyl or methylcyclopentad ienyl and

alkynyl ethynyl, 1,2-propynyl, 2-butynyl, 1,3-butadiynyl, pentynyl or hexynyl.

The larger the number of alkoxy radicals in the SiR′ₙ(OR′)₃₋ₙ group and thus the smaller is n, the larger can be the number of covalent bonds between the metal oxide and the compounds of the general formulae (I) and (II) after immobilisation.

The SiR′ₙ(OR′)₃₋ₙ group is bonded to the nitrogen atom of the heterocyclic radical via a hydrocarbon radical R.

The hydrocarbon radical R is preferably a radical having 1-30 carbon atoms. This hydrocarbon radical may be straight-chain, unbranched (linear), branched, saturated, mono- or polyunsaturated, cyclic (A) or aromatic (Ar), heterocyclic or heteroaromatic (Het) and optionally mono- or polysubstituted.

The hydrocarbon radical R can be an A, Ar, A-Ar, A-Ar-A, Het, A-Het or A-Het-A radical, where each of the groups A, Ar and Het can adopt the meanings given below. R is preferably an A, Ar, A-Ar or A-Ar-A radical having not more than 20 carbon atoms.

A is straight-chain, unbranched (linear), branched, saturated, mono- or polyunsaturated or cyclic alkyl radical A having 1, 2, 3, 4, 5, 6, 7, 8, 9,10, 11, 12, 13,14,15, 16, 17,18,19, 20, 21, 22, 23, 24, 25, 26, 27, 28, 29 or 30 carbon atoms, preferably having 1, 2, 3, 4, 5, 6, 7, 8, 9,10,11 or 12 carbon atoms.

A is preferably a straight-chain or branched, saturated C¹-C₁₂-alkyl radical or a cycloalkyl having 3-10 carbon atoms or a C₄-C₂₀-cycloalkyl bonded via one or two alkyl group(s).

Alkylene has the same meanings as indicated for A, with the proviso that a further bond exists from the alkyl to the closest bonding neighbour.

A is, for example, an alkylene group selected from the group consisting of methylene (—CH₂—), ethylene (—C₂H₄—), propylene (—C₃H₆—), isopropylene (—C₃H₆—), butylene (—C₄H₈—), isobutylene (—C₄H₈—), sec-butylene (—C₄H₈—) and tert-butylene (—C₄H₈—), furthermore also pentylene (—C₅H₁₀—), 1-, 2- or 3-methylbutylene (—C₅H₁₀—), 1,1-, 1,2- or 2,2-dimethylpropylene (—C₅H₁₀—), 1-ethylpropylene (—C₅H₁₀—), hexylene (—C₆H₁₂—), 1-, 2-, 3- or 4-methyl-pentylene (—C₆H₁₂—), 1,1-, 1,2-, 1,3-, 2,2-, 2,3- or 3,3-dimethylbutylene (—C₆H₁₂—), 1 - or 2-ethylbutylene (—C₆H₁₂—), 1-ethyl-1 -methylpropylene (—C₆H₁₂—), 1-ethyl-2-methylpropylene (—C₆H₁₂—), 1,1,2- or 1,2,2-trimethyl-propylene (—C₆H₁₂—), heptylene, octylene, nonylene, decylene, undecylene or dodecylene.

A can also be a cycloalkylene group having 3-30 carbon atoms, preferably C₃-C₉-cycloalkylene. Cycloalkyl here can be saturated or unsaturated and optionally bonded via one or two alkyl groups in the molecule to the imidazole nitrogen and the SiR′ₙ(OR′)ₙ₋₃ group. One or more H atom(s) may also be replaced by other substituents in the cycloalkylene group. Cycloalkyl is preferably cyclopropyl, cyclobutyl, cyclopentyl, cyclohexyl, methyl-cyclopentyl, cycloheptyl, methylcyclohexyl, cyclooctyl, 3-menthyl or camphor-10-yl (bicyclic terpene), decalin or bicycloheptane, where these groups can be bonded via one or two alkyl groups in the molecule to the imidazole nitrogen and the SiR′ₙ(OR′)ₙ₋₃ group.

In this case, cycloalkyl is preferably 1,2-cyclopropyl, 1,2- or 1,3-cyclobutyl, 1,2-or 1,3-cyclopentyl, or 1,2-, 1,3- or 1,4-cyclohexyl, furthermore 1,2-, 1,3- or 1,4-cycloheptyl. However, the said groups can also, as R3, be bonded in substituted or unsubstituted form to the second imidazole nitrogen.

A can also be an unsaturated alkenyl or alkynyl group having 2-20 carbon atoms, which can be bonded both to the imidazole nitrogen or an imidazole carbon and to the SiR′ₙ(OR′)ₙ₋₃ group.

Alkenyl groups can be straight-chain, branched or cyclic C₂-C₃₀-alkenyl groups, preferably straight-chain, branched or cyclic C₂-C₉-alkenyl groups, particularly preferably straight-chain or branched C₂-C₆-alkenyl groups from the group consisting of vinyl, propenyl, butenyl, pentenyl and hexenyl.

Cycloalkenyl groups can be straight-chain or branched C₃-C₃₀-cycloalkenyl groups, preferably C₃-C₉-cycloalkenyl groups, particularly preferably C₃-C₆-cycloalkenyl groups from the group consisting of cyclopropenyl, cyclobutenyl, cyclopentenyl, cyclohexenyl, cyclopentadienyl and methylcyclopentadienyl.

Alkynyl groups can be straight-chain or branched C₂-C₃₀-alkynyl groups, preferably straight-chain or branched C₂-C₉-alkynyl groups, particularly preferably straight-chain or branched C₂-C₆-alkynyl groups from the group consisting of ethynyl, propynyl, butynyl, pentynyl and hexynyl.

If alkenyl, cycloalkenyl or alkynyl is part of the hydrocarbon radical R, it of course has the same meanings, with the proviso that a further bond exists from the alkenyl or from the alkynyl to the closest bonding neighbour in the molecule.

Ar is a mono- or polycyclic aromatic hydrocarbon radical having 6-30 carbon atoms, which may be mono- or polysubstituted or unsubstituted.

Ar is preferably a mono- or polysubstituted phenyl or naphthyl, where substituents can adopt the meanings of A, and Ar has a total of not more than 20 carbon atoms.

Aryl groups can preferably be C₆-C₁₀-aryl groups, preferably phenyl or naphthyl. Alkylaryl groups can be C₇-C₁₈-alkylaryl groups, preferably tolyl or mesityl.

Ar is preferably substituted or unsubstituted phenyl, naphthyl, anthryl or phenanthryl, each of which may be mono-, di- or trisubstituted by A, OA, CO-AOH, COOH, COOA, fluorine, chlorine, bromine, iodine, hydroxyl, methoxy, ethoxy, propoxy, butoxy, pentyloxy, hexyloxy, nitro, cyano, formyl, acetyl, propionyl, trifluoromethyl, amino, methylamino, ethylamino, dimethylamino, diethylamino, benzyloxy, sulfonamido, methylthio, methylsulfinyl, methylsulfonyl, methylsulfonamido, ethylsulfonamido, propylsulfonamido, butylsulfonamido, dimethylsulfonamido, phenylsulfonamido, carboxyl, methoxycarbonyl, ethoxycarbonyl or aminocarbonyi, where Ar has not more than 20 carbon atoms if it is substituted by A and/or bonded to A.

Ar is preferably unsubstituted or mono- or polysubstituted phenyl, and specifically preferably phenyl, o-, m- or p-tolyl, o-, m- or p-ethylphenyl, o-, m- or p-propylphenyl, o-, m- or p-isopropylphenyl, o-, m- or p-tert-butylphenyl, o-, m- or p-cyanophenyl, o-, m- or p-methoxyphenyl, o-, m- or p-ethoxyphenyl, o-, m- or p-fluorophenyl, o-, m- or p-bromophenyl, o-, m- or p-chlorophenyl, o-, m- or p-methylthiophenyl, o-, m- or p-methyl-sulfinylphenyl, o-, m- or p-methylsulfonylphenyl, o-, m- or p-aminophenyl, o-, m- or p-methylaminophenyl, o-, m- or p-dimethylaminophenyl, o-, m- or p-nitrophenyl, 2,3-, 2,4-, 2,5-, 2,6-, 3,4- or 3,5-difluorophenyl, 2,3-, 2,4-, 2,5-, 2,6-, 3,4- or 3,5-dichlorophenyl, 2,3-, 2,4-, 2,5-, 2,6-, 3,4- or 3,5-dibromophenyl, 2-chloro-3-methyl-, 2-chloro-4-methyl-, 2-chloro-5-methyl-, 2-chloro-6-methyl-, 2-methyl-3-chloro-, 2-methyl-4-chloro-, 2-methyl-5-chloro-, 2-methyl-6-chloro-, 3-chloro-4-methyl-, 3-chloro-5-methyl- or 3-methyl-4-chlorophenyl, 2-bromo-3-methyl-, 2-bromo-4-methyl-, 2-bromo-5-methyl-, 2-bromo-6-methyl-, 2-methyl-3-bromo-, 2-methyl-4-bromo-, 2-methyl-5-bromo-, 2-methyl-6-bromo-, 3-bromo-4-methyl-, 3-bromo-5-methyl- or 3-methyl-4-bromophenyl, 2,4- or 2,5-dinitrophenyl, 2,5- or 3,4-dimethoxyphenyl, 2,3,4-, 2,3,5-, 2,3,6-, 2,4,6- or 3,4,5-trichlorophenyl, 2,4,6-tri-tert-butylphenyl, 2,5-dimethylphenyl, 4-iodophenyl, 4-fluoro-3-chlorophenyl, 4-fluoro-3,5-dimethylphenyl, 2-fluoro-4-bromophenyl, 2,5-difluoro-4-bromophenyl, 2,4-dichioro-5-methylphenyl, 3-bromo-6-methoxy-phenyl, 3-chloro-6-methoxyphenyl, 2-methoxy-5-methylphenyl, 2,4,6-tri-isopropyl phenyl, 1,3-benzodioxol-5-yl, 1,4-benzodioxan-6-yl, benzothia-diazol-5-yl or benzoxadiazol-5-yl or naphthyl.

Arylene has the same meanings as indicated for Ar, with the proviso that a further bond exists from the aromatic system to the closest bonding neighbour.

Specifically, the group referred to as Het can adopt the following meanings:

Het is a mono- or bicyclic saturated, unsaturated or aromatic heterocyclic radical having from 1 to 4 N, O and/or S atoms, which may be unsubstituted or mono-, di- or trisubstituted by Hal and/or A, OA, CO-AOH, COOH, COOA, COA, OH, CN, CONHA, N0₂, =NH or =O, where Hal is F, Cl, Br or I.

Het is preferably chromen-2-onyl, pyrrolyl, imidazolyl, pyridyl, pyrimidyl, piperidinyl, 1-methylpiperidinyl, indolyl, thiophenyl, furyl, imidazolyl, pyrazolyl, oxazolyl, isoxazolyl, thiazolyl, isothiazolyl, triazolyl, thienyl, tetrazolyl, oxadiazolyl, thiadiazolyl, thiopyranyl, pyridazinyl, pyrazyl, benzofuryl, benzothienyl, indolyl, 2,1,3-benzothiadiazolyl, benzimidazolyl, benzopyrazolyl, benzoxazolyl, benzisoxazolyl, benzothiazolyl, benzisothiazolyl, benz-2,1,3-oxadiazolyl, quinolyl, isoquinolyl or cinnolinyl, each of which is unsubstituted or mono- or disubstituted by Hal and/or A, where substituents can be A, OA, CO-AOH, COOH, COOA, fluorine, chlorine, bromine or iodine.

Het is particularly preferably 2- or 3-furyl, 2- or 3-thienyl, 1-, 2- or 3-pyrrolyl, 1-, 2-, 4- or 5-imidazolyl, 1-, 3-, 4- or 5-pyrazolyl, 2-, 4- or 5-oxazolyl, 3-, 4- or 5-isoxazolyl, 2-, 4- or 5-thiazolyl, 3-, 4- or 5-isothiazolyl, 2-, 3- or 4-pyridyl, 1-methylpiperidin-4-yl or piperidin-4-yl, or 2-, 4-, 5- or 6-pyrimidinyl, furthermore preferably 1,2,3-triazol-1-, -4- or-5-yl, 1,2,4-triazol-1-, -3- or -5-yl, 1- or 5-tetrazolyl, 1,2,3-oxadiazol-4- or -5-yl, 1,2,4-oxadiazol-3- or -5-yl, 1,3,4-thiadiazol-2- or -5-yl, 1,2,4-thiadiazol-3- or -5-yl, 1,2,3-thiadiazol-4- or -5-yl, 2-, 3-, 4-, 5- or 6-2H-thiopyranyl, 2-, 3- or 4-4-H-thiopyranyl, 3- or 4-pyridazinyl, pyrazinyl, 2-, 3-, 4-, 5-, 6-or 7-benzofuryl, 2-, 3-, 4-, 5-, 6- or 7-benzothienyl, 1-, 2-, 3-, 4-, 5-, 6- or 7-indolyl, 1-, 2-, 4- or 5-benzimidazolyl, 1-, 3-, 4-, 5-, 6- or 7-benzo-pyrazolyl, 2-, 4-, 5-, 6- or 7-benzoxazolyl, 3-, 4-, 5-, 6- or 7-benz-isoxazolyl, 2-, 4-, 5-, 6- or 7-benzothiazolyl, 2-, 4-, 5-, 6- or 7-benziso-thiazolyl, 4-, 5-, 6- or 7-benz-2,1,3-oxadiazolyl, 2-, 3-, 4-, 5-, 6-, 7- or 8-quinolyl, 1-, 3-, 4-, 5-, 6-, 7- or 8-isoquinolyl, 3-, 4-, 5-, 6-, 7- or 8-cinnolinyl, 2-, 4-, 5-, 6-, 7- or 8-quinazolinyl, 4- or 5-isoindolyl, 5- or 6-quinoxalinyl, 2-, 3-, 5-, 6-, 7- or 8-2H-benzo[1,4]oxazinyl, furthermore preferably 1,3-benzodioxol-5-yl, 1,4-benzodioxan-6-yl, 2,1,3-benzothia-diazol-4- or -5-yl, 2,1,3-benzoxadiazol-5-yl or chromenyl.

The heterocyclic radicals may also be partially or completely hydrogenated and adopt the following meanings:

Het is 2,3-dihydro-2-, -3-, -4- or -5-furyl, 2,5-dihydro-2-, -3-, -4- or-5-furyl, tetrahydro-2- or -3-furyl, 1,3-dioxolan-4-yl, tetrahydro-2- or -3-thienyl, 2,3-dihydro-1-, -2-, -3-, -4- or -5-pyrrolyl, 2,5-dihydro-1-, -2-, -3-, -4- or -5-pyrrolyl, 1-, 2- or 3-pyrrolidinyl, tetrahydro-1-, -2- or -4-imidazolyl, 2,3-dihydro-1-, -2-, -3-, -4- or -5-pyrazolyl, tetrahydro-1-, -3- or -4-pyrazolyl, 1,4-dihydro-1-, -2-, -3- or -4-pyridyl, 1,2,3,4-tetrahydro-1-, -2-, -3-, -4-, -5- or -6-pyridyl, 1-, 2-, 3- or 4-piperidinyl, 2-, 3- or 4-morpholinyl, tetrahydro-2-, -3- or -4-pyranyl, 1,4-dioxanyl, 1,3-dioxan-2-, -4- or -5-yl, hexahydro-1-, -3- or -4-pyridazinyl, hexahydro-1-, -2-, -4- or -5-pyrimidinyl, 1-, 2- or 3-piperazinyl, 1,2,3,4-tetrahydro-1-, -2-, -3-, -4-, -5-, -6-, -7- or -8-quinolyl, 1,2,3,4-tetrahydro-1-, -2-, -3-, -4-, -5-, -6-, -7- or -8-isoquinolyl, or 2-, 3-, 5-, 6-, 7- or 8-3,4-dihydro-2H-benzo[1,4]oxazinyl, furthermore preferably 2,3-methylenedioxyphenyl, 3,4-methylenedioxyphenyl, 2,3-ethylenedioxy-phenyl, 3,4-ethylenedioxyphenyl, 3,4-(difluoromethylenedioxy)phenyl, 2,3-dihydrobenzofuran-5- or -6-yl, 2,3-(2-oxomethylenedioxy)phenyl or alternatively 3,4-dihydro-2H-1,5-benzodioxepin-6- or -7-yl, furthermore preferably 2,3-dihydrobenzofuranyl or 2,3-dihydro-2-oxofuranyl.

Heterocycloalkylene or heterocycloarylene has the same meanings as indicated for Het, with the proviso that a further bond exists from the heterocyclic system to the closest bonding neighbour.

Heterocycloalkylene is preferably 1,2-, 2,3- or 1,3-pyrrolidinyl, 1,2-, 2,4-, 4,5- or 1,5-imidazolidinyl, 1,2-, 2,3- or 1,3-pyrazolidinyl, 2,3-, 3,4-, 4,5- or 2,5-oxazolidinyl, 1,2-, 2,3-, 3,4- or 1,4-isoxazolidinyl, 2,3-, 3,4-, 4,5- or 2,5-thiazolidinyl, 2,3-, 3,4-, 4,5- or 2,5-isothiazolidinyl, 1,2-, 2,3-, 3,4- or 1,4-piperidinyl, or 1,4- or 1,2-piperazinyl, furthermore preferably 1,2,3-tetrahydrotriazol-1,2- or -1,4-yl, 1,2,4-tetrahydrotriazol-1,2- or -3,5-yl, 1,2- or 2,5-tetrahydrotetrazolyl, 1,2,3-tetrahyd rooxadiazol-2,3-, -3,4-, -4,5- or -1,5-yl, 1,2,4-tetrahydrooxadiazol-2,3-, -3,4- or -4,5-yl, 1,3,4-tetrahydrothiadiazol-2,3-, -3,4-, -4,5- or -1,5-yl, 1,2,4-tetrahydrothiadiazol-2,3-, -3,4-, -4,5- or -1,5-yl, 1,2,3-thiadiazol-2,3-, -3,4-, -4,5- or -1,5-yl, 2,3- or 3,4-morpholinyl, or 2,3-, 3,4- or 2,4-thiomorpholinyl.

The hydrocarbon radical R is very particularly preferably a group having not more than 20 carbon atoms and adopts meanings selected from compounds which count amongst the C₁-C₁₂-alkylene groups, C₃-C₁₀-cycloalkylene groups, or C₄-C₂₀-cycloalkylene groups, C₆-C₁₄-arylene groups or C₇-C₂₀-alkylarylene groups, bonded via one or two alkyl group(s), and of these particularly preferably a C₁-C₄-alkylene chain from the series consisting of methylene, ethylene, propylene and butylene or a C₆-C₈-arylene chain from the series consisting of -C₆H₄- and -C₆H₂Me₂- or a C₇-C₉-alkylaryl chain from the series consisting of -CH₂C₆H₄-, -CH₂C₆H₂Me₂-, -CH₂C₆H₄CH₂- and -CH₂C₆H₂Me₂CH₂-.

R3 is a hydrocarbon radical which can adopt all meanings of A, Ar, AAr, AArA, Het, AHet or AHetA, in which H atoms may be replaced by functional groups Z. This hydrocarbon radical may be straight-chain, unbranched (linear), branched, saturated, mono- or polyunsaturated, cyclic (A) or aromatic (Ar), heterocyclic or heteroaromatic (Het) and optionally mono- or polysubstituted. The hydrocarbon radical R3 is in particular a radical which exerts a stabilising action on the carbene function of the compounds of the general formulae (I) and (II). The H atoms in R3 may be replaced by functional groups Z as defined below. R3 is preferably an aliphatic, aromatic or heteroaromatic hydrocarbon radical, more precisely, as described above, an aliphatic radical A, an aromatic hydro-carbon Ar from the groups listed above or a heterocyclic substituent Het as defined above. R3 is very preferably an aliphatic, i.e. a straight-chain, unbranched (linear), branched, saturated, mono- or polyunsaturated or cyclic aliphatic or aromatic hydrocarbon radical having 1-18 carbon atoms. From this group of compounds, the radicals phenyl, tolyl, 2,6-dimethylphenyl, mesityl, 2,6-diisopropylphenyl, 2,4,6-triisopropylphenyl or cyclohexyl have proven particularly suitable and have resulted in particularly advantageous properties of the compounds prepared.

R1 and R2, independently of one another, can be H or can adopt all meanings of Hal, A, Ar and AAr as indicated above, where H atoms in A and Ar may be replaced by functional groups Z, and Hal can be F, Cl, Br or l. R1 and R2 particularly preferably adopt the meanings of R3 or are H, Cl or Br. R1 and R2 are particularly preferably, independently of one another, H, Cl, Br, a straight-chain, branched, saturated or mono- or polyunsaturated C₁-C7-alkyl radical, where one or more H in the alkyl radical may be replaced by Z.

As already described, H atoms in all hydrocarbon radicals R, R1, R2 and R3, but in particular in R3, may be replaced by functional groups Z and carry N, P, O or S atoms. They can be groups which have one or more alcohol, aldehyde, carboxyl, amine, amide, imide, phosphine, ether or thioether functions, i.e. they can be, inter alia, radicals having the meanings OA, NHA, NM′, PM′, CN, NO₂, SA, SOA, SO₂A or SO₂Ar, where A, A′ and A″, independently of one another, can adopt the meanings of A in accordance with the definition given. They can be groups which have one or more alcohol (OA), aldehyde, carboxyl, amine, amide, imide, phosphine, ether or thioether functions. A group Z preferably has the meaning OA, NHA, NAA′ or PAA′.

R1 and R2 can therefore, for example, also be SO₃H, F, Cl, or a hydroxyl, alkanoyl or cycloalkanoyl radical. R1, R2 and R3 can be methoxy, ethoxy, propionyl, butyryl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl or octadecanoyl.

R1, R2 and R3 can also be acyl radicals. R1, R2 and R3 can preferably be acyl radicals having 1, 2, 3,4, 5, 6, 7,8,9 or 10 carbon atoms and can be, for example, formyl, acetyl, propionyl, butyryl, trifluoroacetyl, benzoyl or naphthoyl. R1, R2 and R3 can furthermore be amino, methylamino, dimethylamino, methylthio, methylsulfinyl, methylsulfonyl or phenylsulfonyl groups.

In addition, one, two or three methylene groups in the radicals R1, R2 and R3 in alkyl, alkylene, cycloalkyl, cycloalkylene, alkanoyl and cycloalkanoyl may each be replaced by N, O and/or S.

A hydrocarbon group in R1, R2 and R3 can thus adopt the meanings of A, Ar or Mr and can be an alkyl, alkenyl, aryl, alkylaryl or alkynyl group as defined above, in which one or more H atoms may be replaced by the above-mentioned functional groups Z.

R4 can, independently of one another, be A, Ar or Mr, as defined above, and can in particular be an alkyl, cycloalkyl or aryl group having up to 10 carbon atoms. R4 is preferably C₁-C₆-alkyl, C₅-C₈-cycloalkyl or C₆-C₁₀-aryl and can preferably have the meanings methyl, ethyl, propyl, i-propyl, butyl, i-butyl, secbutyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methylpropyl (—C₆H₁₂—), 1-ethyl-2-methylpropyl (—C₆H₁₂—), 1,1,2- or 1,2,2-trimethylpropyl (—C₆H₁₂—), cyclopentyl, cyclohexyl, methylcyclopentyl, cycloheptyl, methylcyclohexyl, cyclooctyl, phenyl, o-, m- or p-tolyl, o-, m- or p-ethylphenyl, o-, m- or p-propylphenyl, o-, m- or p-isopropylphenyl, o-, m- or p-tert-butylphenyl or naphthyl. R4 is very preferably cyclohexyl, cyclopentyl, isopropyl or phenyl.

R5 and R6, independently of one another, can be H, A or Ar, where H atoms in A or Ar may be substituted by alkenyl or alkynyl radicals, having not more than 30 carbon atoms. R5 and R6 can therefore, independently of one another, be H, alkyl, cycloalkyl, aryl, alkenyl or alkynyl having up to 30 carbon atoms. R5 and R6 are preferably H, C₁-C₁₀-alkyl, C₆-C₁₀-aryl, C₂-C₁₀-alkenyl or C₂-C₈-alkynyl. R5 and R6 can thus preferably adopt the meanings methyl, ethyl, propyl, i-propyl, butyl, i-butyl, sec-butyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methyl-propyl (—C₆H₁₂—), 1-ethyl-2-methylpropyl (—C₆H₁₂—), 1,1,2- or 1,2,2-trimethylpropyl (—C₆H₁₂—), heptyl, octyl, nonyl, decyl, cyclopropenyl, cyclobutenyl, cyclopentenyl, cyclohexenyl, cyclopentadienyl and methylcyclopentadienyl, phenyl, o-, m- or p-tolyl, o-, m- or p-ethylphenyl, o-, m- or p-propylphenyl, o-, m- or p-isopropyl-phenyl, o-, m- or p-tert-butylphenyl, naphthyl, vinyl, propenyl, butenyl, pentenyl or hexenyl, ethynyl, propynyl, butynyl, pentynyl or hexynyl. R5 and R6 are very preferably H, methyl, phenyl or C₂-C₈-alkenyl, such as, for example, vinyl, —C=CMe₂ or —C=CPh₂.

X is in each case a monovalent anion which is bonded, for charge equalisation, as ligand to a doubly positively charged ruthenium central atom. Depending on the electronegativity of the anion X, this bond can be a coordinative bond formed by free electron pairs of the anion, or an ionic bond.

The two anions X present in the compounds (I) and (II) can be, independently of one another, halide (Hal) from the group consisting of Br^{-,} Cl⁻, l⁻ and F⁻, pseudohalide, such as cyanide (CN⁻) and thiocyanate (SCN⁻), alkoxide, aryl oxide, alkyl, aryl, carboxyl, etc. X is preferably halide, very preferably Cl or Br.

The imidazole parent structures of the substituted imidazoles required as starting materials for the preparation of the compounds of the general formula (I) can be prepared analogously to the synthetic method described in Patent Specification US-A-6,177,575 in accordance with the following general reaction equation:

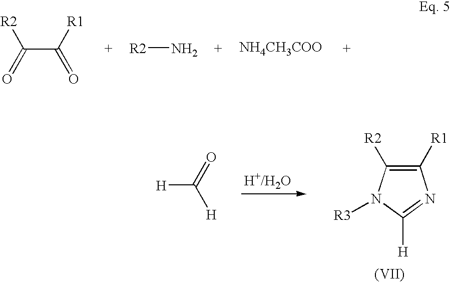

The parent structure (VIII) of the compounds of the general formula (II) (substituted 4,5-dihydroimidazole) can be synthesised by methods which are described in Tetrahedron Lett. 1980, 21, 885, Chem. Ber. 1965, 98, 1342 and in DE-A-11 89 998.

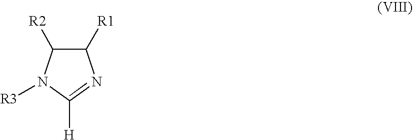

The preparation of the compounds of the general formulae (Ill) and (IV) substituted by silyl groups on the second nitrogen atom of the imidazole ring can be carried out in a simple manner by reaction of a substituted imidazole of the general formula (VII) or substituted 4,5-dihydroimidazole of the general formula (VIII) with chlorine-, bromine- or iodine-containing alkoxysilanes of the general formula (IX)
Hal-R-SiR′ₙ(OR′)₃₋ₙ (IX)
without addition of a further solvent under a protective-gas atmosphere. However, it is also possible to carry out the reaction in an inert, aprotic, organic solvent.

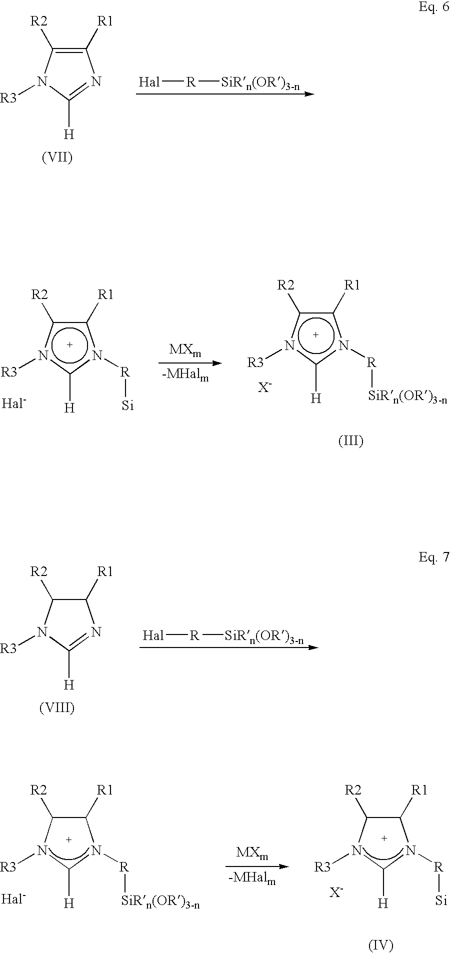

Depending on the reactivity of the imidazole of the general formula (VII) or (VIII) employed, the reaction is carried out with maintenance of the reaction temperature within a short time or requires a number of days. The reaction temperature is in the range from 20 to +200° C., preferably from 20 to 100° C. and very preferably between 60 and 100° C. After completion of the reaction, the products (Ill) and (IV) formed can be isolated in pure form as stable substances by known methods and converted further by method A into the compounds of the general formulae (I) and (II).

The compounds of the general formulae (V) and (VI) are prepared by reaction (reaction equations Eq. 8 and Eq. 9) of the alkoxysilyl-functionalised imidazolium salts (Ill) or alkoxysilyl-functionalised 4,5-dihydroimidazolium salts (IV) with a suitable base in anhydrous, inert, aprotic, organic solvents under a protective-gas atmosphere.

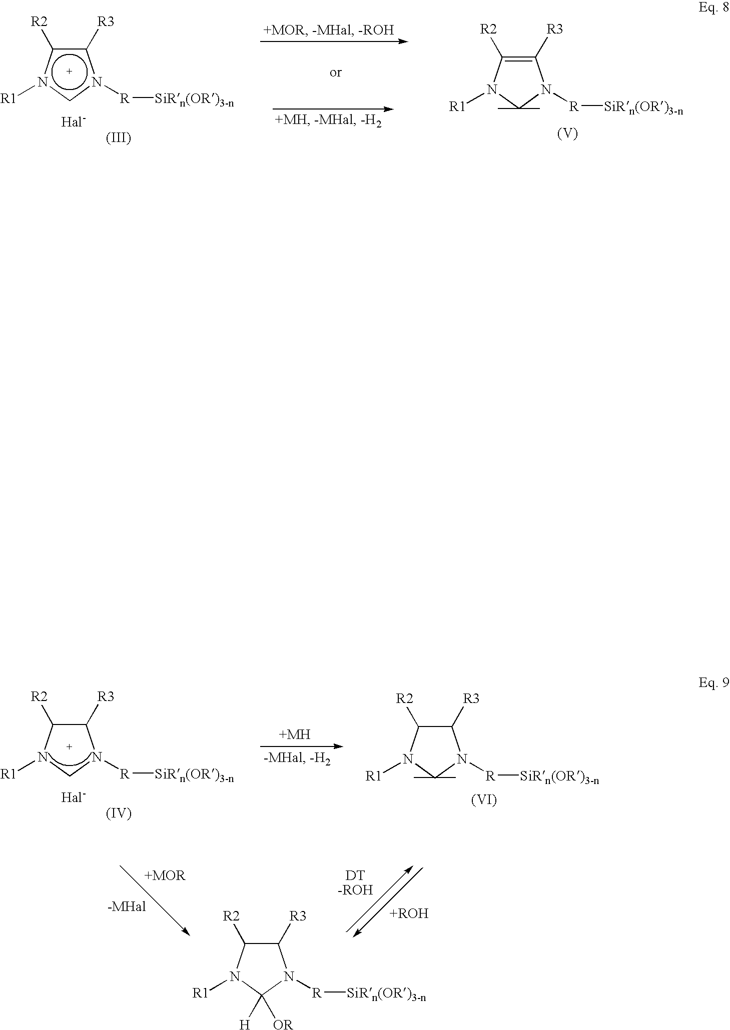

This reaction can, if desired, be carried out directly after the preparation of the imidazolium salts (III) or 4,5-dihydroimidazolium salts (IV) without prior purification. Bases which are suitable for this reaction are metal alkoxides of the general formula MOR or bases selected from the group consisting of the metal hydrides MH, metal amides MNH₂ and ammonia in an anhydrous, inert, aprotic, organic solvent. Preference is given to the use of NH₃/NaH or a metal hydride MH or a metal alkoxide MOR as base. Potassium t-butoxide (KO^{t}Bu) and potassium hydride (KH) have proven very particularly suitable in various reactions.

For the reaction, all reactants can be introduced together into the reaction vessel. The sequence of addition of the components can be selected as desired. The starting compounds of the general formulae (Ill) and (IV) can be pre-dissolved or suspended in a suitable solvent, such as, for example, an ether. The protective-gas atmosphere used can be nitrogen or argon. This reaction can be carried out at a temperature in the range from −78° C. to +100° C., preferably from −40° C. to +60° C., for a reaction time of from 1 minute to 6 hours. The products of the general formulae (V) and (VI) formed can, where appropriate after removal of solid by-products and removal of the volatile constituents, be isolated in pure form in a simple manner by extraction and crystallisation or converted directly into the compounds of the general formula (I) or (II) by method B.

The compounds of the general formulae (I) and (II) can firstly be prepared by reaction of compounds of the general formulae (Ill) and (IV) respectively with a base which is capable of deprotonation of (III) and (IV) respectively, such as, for example, metal alkoxides MOR, metal hydrides MH, metal amides MNH₂ or ammonia in the presence of a ruthenium compound of the general formula (X)
[P(R4)₃]₂X₂Ru=CR5R6 (X)
in anhydrous, inert, aprotic, organic solvents (method A).

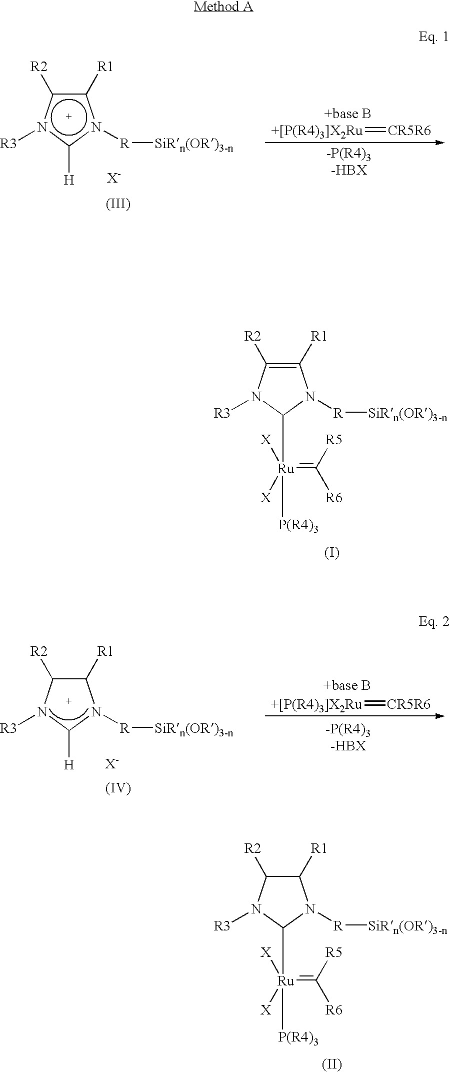

The base used is preferably potassium t-butoxide (KO^{t}Bu) or potassium hydride (KH). The sequence of addition of the components can be selected as desired. The starting compounds can be pre-dissolved or suspended in a suitable inert solvent. The solvents used are preferably pure hydrocarbons and cyclic ethers. Of the pure hydrocarbons, preference is given to the use of pentane, hexane, heptane, octane, decane, benzene or toluene, very preferably heptane or toluene. Of the cyclic ethers, preference is given to the use of tetrahydrofuran.

The protective-gas atmosphere used can be nitrogen or argon.

The addition of copper(l) chloride to the reaction solution (Eq. 1 and 2) as scavenging reagent for the P(R4)₃ being liberated has proven advantageous, in particular for increasing the yield of the compounds of the general formulae (I) and (II).

For the preparation of the compounds of the general formula (I) or (II), the base used and the ruthenium starting compound are generally employed in a slight to significant excess compared with the starting compounds of the general formulae (Ill) and (IV). The stoichiometric ratio of the compounds of the general formulae (Ill) and (IV) to the base employed and to the ruthenium starting compound is therefore in the range between 1:1:1 and 1:1.5:1.5, where the stoichiometric ratio of the base employed and of the ruthenium starting compound to one another are independent of one another. Accordingly, the stoichiometric ratio of the compounds (Ill) and (IV) to the base employed can be in the range between 1:1 and 1:1.5, and the ratio of base to ruthenium starting compound or ruthenium starting compound to base can be, independently thereof, in the range between 1:1.5. Consequently, the stoichiometric ratios of the compounds of the general formulae (Ill) and (IV) to the base employed and to the ruthenium starting compound of 1:1.5:1 or 1:1:1.5 are also covered as suitable stoichiometric starting-material ratios. The stoichiometric ratio is preferably in the range between 1:1:1 and 1:1.2:1.2.

The reaction can be carried out at a temperature in the range from −78° C. to +150° C., preferably from −20° C. to +100° C. The reaction is very preferably carried out at a temperature in the range between 0° C. and 80° C.

The reaction duration is from 30 minutes to two days, preferably from one hour to 24 hours and very preferably from one hour to 12 hours.

When the reaction is complete and the volatile constituents have been removed in a high vacuum, the product is separated off by extraction with a nonpolar aprotic solvent or the by-products can also be separated off from the product by filtration. The compounds of the general formulae (I) and (II) can be isolated in pure form as substances or can be purified by means of crystallisation or chromatography using RP silica.

As has already been mentioned above, the compounds of the general formulae (I) and (II) can also be prepared by reaction of compounds of the general formulae (V) and (VI) respectively with a ruthenium compound of the general formula (X)
[P(R4)₃]₂X₂Ru=CR5R6, (X)
in which R4, R5, R6 and X are as defined above, in anhydrous, inert, aprotic, organic solvents (method B).

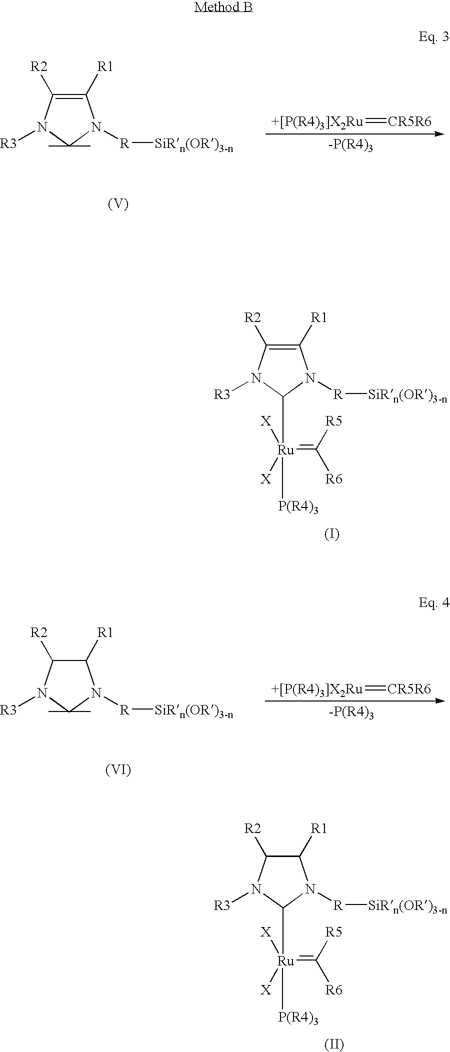

In order to carry out method B, the components can be added in any desired sequence. The starting compounds can be pre-dissolved or suspended in a suitable solvent. The solvents used for this purpose are preferably pure hydrocarbons and cyclic ethers. Of the pure hydrocarbons, preference is given to the use of pentane, hexane, heptane, octane, decane, benzene or toluene and very preferably heptane or toluene. Of the cyclic ethers, preference is given to the use of tetrahydrofuran.

The protective-gas atmosphere used can be nitrogen or argon.

The addition of copper(l) chloride to the reaction solution (Eq. 1 and 2) as scavenging reagent for the P(R4)₃ being liberated has proven advantageous, in particular for increasing the yield of the compounds of the general formulae (I) and (II).

For carrying out the reaction, it is advantageous to employ the ruthenium starting compound in a slight stoichiometric excess with respect to the compound of the general formula (V) or (VI). The stoichiometric ratio of the compound of the general formula (V) or (VI) employed to the ruthenium starting compound can therefore be in the range between 1:1 and 1:1.5, preferably between 1:1 and 1:1.2.

The reaction can be carried out at a temperature in the range from −78° C. to +100° C., preferably at a temperature in the range from −20° C. to +80° C. In the majority of cases, very good results are achieved in the very preferred temperature range between 0° C. and 40° C.

In general, the reaction time is from 30 minutes to 2 days, preferably from one hour to 24 hours. The reaction is usually already complete in a time between one hour and 12 hours. After the removal of the volatile constituents in a high vacuum, the compounds of the general formulae (I) and (II) are obtained in pure form by crystallisation or chromatographic treatment by means of RP silica.

Preparation method A is preferred since this is a one-pot synthesis which starts from more stable starting materials, and the ligands necessary for the formation of (I) and (II) (compounds (V) and (VI)) are prepared in situ.

Performance of the reactions by method A or B is not crucial per se. The reactions can be carried out in a simple manner in plants in which all parts and devices which come into contact with the reactants are inert to the chemicals employed and exhibit no corrosion or leaching phenomena. It is crucial that the plant used can be temperature-controlled, offers safe feed and discharge of the reactants and reaction products and has means for intensive mixing of the reaction solution. Furthermore, the plant should facilitate working under an inert-gas atmosphere and the safe discharge of volatile substances. Accordingly, the reactions can also be carried out in a glass apparatus fitted with stirrer, feed and optionally outlet, with reflux condenser or condensation cooler with outflow if this apparatus also offers the possibility of blanketing with inert gas. However, the reactions can also be carried out in an industrial plant which is made, if desired, of stainless steel or other suitable inert materials and has the requisite devices for temperature control, feed and discharge of the starting materials and products.

The reactions are usually carried out in batch operation, in particular if the reactions take place slowly.

If relatively large amounts of the desired products of the general formulae (I) and (II) are to be prepared and if the starting materials to be reacted are reactive compounds, it may be appropriate to carry out the reactions in a corresponding plant designed for continuous operation.

The compounds of the general formulae (I) and (II) can be used as catalysts in organic and organometallic synthesis. They furthermore serve as starting materials for the preparation of immobilised catalysts, which can in turn be employed in organic and organometallic synthesis. In particular, they can be used as catalysts in C-C coupling reactions, hydrogenations, isomerisations, silylations and hydroformylation. The novel compounds are particularly suitable as catalysts for C-C coupling, such as olefin metathesis, and for hydrogenation reactions. The novel compounds are particularly advantageous in olefin metathesis reactions, such as cross metathesis (CM), ring closure metathesis (RCM), ring opening metathesis polymerisation (ROMP), acyclic diene metathesis polymerisation (ADMET) and ene-yne metathesis.

### EXAMPLES

For better understanding and in order to clarify the invention, examples are given below which are within the scope of protection of the present invention. However, owing to the general validity of the inventive principle described, these are not suitable for reducing the scope of protection of the present application merely to these examples.

(A) Preparation of the Catalysts Synthesis of {1-mesityl-3-[3-(triethoxysilyl)propyl]imidazol-2-ylidene}-(PCy₃)Cl₂Ru=CHPh

104 mg (0.24 mmol) of 1-mesityl-3-[3-(triethoxysilyl)propyl]imidazolium chloride, 168 mg (0.20 mmol) of (PCy₃)₂Cl₂Ru=CHPh, 29 mg (0.26 mmol) of potassium tertiary-butoxide and 5 ml of toluene are introduced into a Schlenk tube under an argon atmosphere and stirred overnight at 25° C. The colour of the solution changes from pink to Bordeaux red. The volatile constituents are removed in a high vacuum. The Bordeaux-red, oily residue is taken up in heptane. The precipitate formed is separated off from the solution by filtration. The solvent of the solution is removed in a high vacuum, giving a Bordeaux-red substance in a yield of 63%. ³¹P-NMR (toluene-d₈):δ 34.33. ¹H-NMR (C₆D₆):δ 19.8 (Ru=CH).

Addition of 1.5 equivalents of copper(l) chloride, based on (PCy₃)₂Cl₂Ru=CHPh. enables the yield to be increased to 92%.

Synthesis of {1-mesityl-3-[4-(trimethoxysilyl)benzyl]imidazol-2-ylidene}-(PCy₃)Cl₂Ru=CHPh

104 mg (0.24 mmol) of 1-mesityl-3-[4-(trimethoxysilyl)benzyl]imidazolium chloride, 29 mg (0.26 mmol) of potassium tertiary-butoxide and 5 ml of THF are introduced into a Schlenk tube under an argon atmosphere and stirred at 25° C. for 1 hour. The volatile components are removed in a high vacuum, and the residue is taken up in heptane. The precipitate formed is removed from the solution by filtration, and the solution is transferred via a cannula into a second Schlenk tube containing 168 mg (0.20 mmol) of (PCy₃)₂Cl₂Ru=CHPh in 5 ml of toluene. The mixture is stirred overnight at 25° C. The colour of the solution changes from pink to bilberry red. The solvent is removed in a high vacuum, giving a bilberry-coloured substance in a yield of 47% .31p (toluene-d₈):δ 36.8. ¹H-NMR (C₆D₆):δ 19.7 (Ru=CH).

Addition of 1.5 equivalents of copper(l) chloride, based on (PCy₃)₂Cl₂Ru=CHPh, enables the yield to be increased to 92%.

(B) Testing of the Catalysts in Olefin Metathesis Metathesis with (PCy₃)₂Cl₂Ru=CHPh

58.2 mg (0.07 mmol) of (PCy₃)₂Cl₂Ru=CHPh, 1.06 ml (7.05 mmol) of 1,7-octadiene and 45 ml of CH₂Cl₂ are introduced into a three-necked flask under an argon atmosphere. The mixture is refluxed, and a sample for gas chromatography is taken every 30 minutes.

GC: 1,7-octadiene:cyclohexene ratio: 1:379 (30 min), 1:456 (60 min), 1:623 (90 min), 1:693 (120 min), 1:695 (150 min), 1:696 (180 min).

Metathesis with [1,3-(bismesityl)imidazol-2-ylidene](PCy₃)Cl₂Ru=CHPh

20 mg (0.02 mmol) of [1,3-(bismesityl)imidazol-2-ylidene](PCy₃)Cl₂Ru=CHPh, 0.35 ml (2.35 mmol) of 1,7-octadiene and 5 ml of CH₂Cl₂ are introduced into a three-necked flask under an argon atmosphere. The mixture is refluxed, and a sample for gas chromatography is taken every 30 minutes.

GC: 1,7-octadiene:cyclohexene ratio: 1:147 (30 min), 1:185 (60 min), 1:203 (90 min), 1:266 (120 min), 1:304 (150 min), 1:384 (180 min).

Metathesis with {1-mesityl-3-[3-(triethoxysilyl)propyl]imidazol-2-ylidene}-(PCy₃)Cl₂Ru=CHPh

{1-Mesityl-3-[3-(triethoxysilyl)propyl]imidazol-2-ylidene}(PCY₃)Cl₂Ru=CHPh is dissolved in 20 ml of heptane under an argon atmosphere, and 1.3 ml (0.85 mmol) of 1,7-octadiene and 55 ml of CH₂Cl₂ are added. The mixture is refluxed, and a sample for gas chromatography is taken every 30 minutes.

GC: 1,7-octadiene:cyclohexene ratio: 1:13 (30 min), 1:100 (60 min), 1:156 (90 min), 1:198 (120 min), 1:243 (150 min), 1:301 (180 min).

1. Compounds of the general formulae (I) and (II) 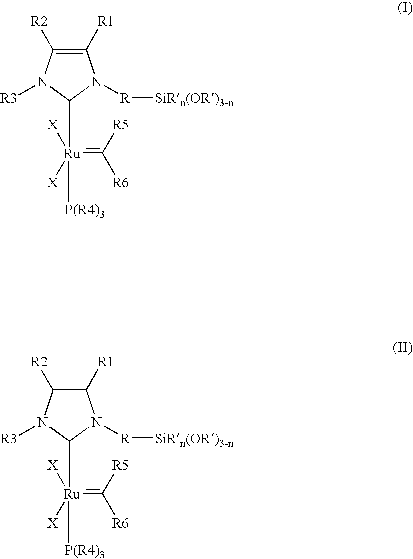
in which
R is A, Ar, A-Ar, A-Ar-A, Het, AHet or AHetA having a total of not more than 30 carbon atoms, where
A is a straight-chain, branched or saturated C₁-C₂₀-alkyl radical, cycloalkyl or cycloalkyl bonded via one or two alkyl group(s) having a total of 4-30 carbon atoms, where one CH₂ or CH group both in the alkyl radical and in the cycloalkyl radical may be replaced by N, NH, NA, 0 and/or S, and H atoms may be replaced by OA, NA₂ and/or PA₂,
Ar is mono- or polysubstituted or unsubstituted phenyl, naphthyl, anthryl or phenanthryl having a total of not more than 20 carbon atoms, where substituents may be A, Hal, OA, NA₂, PA₂, COOA, COA, CN, CONHA, NO₂, =NH or =O,
Het is a monocyclic or bicyclic, saturated or unsaturated or aromatic heterocyclic radical having from 1 to 4 N, O and/or S atoms, which may be unsubstituted or mono-, di- or trisubstituted by Hal and/or A, OA, COOA, COA, CN, CONHA, NA₂, PA₂, NO₂, =NH or =O, where
Hal is F, Cl, Br or I,
R′, independently of the position in the molecule, is A or Ar having 1-12 carbon atoms,
R3 is A, Ar, AAr, AArA, Het, AHet or AHetA having 6-18 carbon atoms, in which the radical A which is not bonded to Ar or Het is an alkyl or cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R1 and R2, independently of one another, are H, Z, Hal or A, Ar, AAr, Het or AHet having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z,
R4 is A, Ar or AAr having 1-30 carbon atoms,
R5 and R6, independently of one another, are H, A or Ar, where H atoms in A or Ar may be substituted by alkenyl or alkynyl radicals, having not more than 30 carbon atoms, where
Hal is F, Cl, Br or I,
Z, independently of the position in R1, R2 and R3, are functional groups containing N, P, Oor S atoms, or A or Ar, and
X are anionic ligands which are identical to or different from one another and which each form a ligand bond to Ru, and
n is0, 1 or 2.

2. Compounds according to claim 1 of the general formulae (I) and (II) in which
R is A, Ar, A-Ar, A-Ar-A, Het, AHet or AHetA having a total of not more than 20 carbon atoms,
R′, independently of the position in the molecule, is a straight-chain, branched, saturated, mono- or polyunsaturated C₁-C₇-alkyl radical,
R3 is A, Ar, AAr, AArA, Het, AHet or AHetA having 1-18 carbon atoms, in which the radical A which is not bonded to Ar or Het is alkyl or cycloalkyl which is unsubstituted or substituted by one or more groups Z, and Ar is an aromatic hydrocarbon which is unsubstituted or mono- or polysubstituted by a group Z, and Het is a saturated, unsaturated or aromatic heterocyclic radical, which may be mono- or polysubstituted by a group Z, and
R1 and R2, independently of one another, are H, Hal or a straight-chain, branched, saturated, mono- or polyunsaturated C₁-C₇-alkyl radical,
R4 is A or Ar having up to 10 carbon atoms,
R5 and R6, independently of one another, are H, alkyl, cycloalkyl, aryl, alkenyl or alkynyl having up to 30 carbon atoms,
Hal is Cl or Br,
X is Br⁻, Cl_{-,}I⁻ or F⁻, cyanide (CN⁻), thiocyanide (SCN⁻), alkoxide, aryl oxide, alkyl, aryl or carboxyl,
Z is A and
n is0, and A, Ar and Het are as defined in claim 1.

3. Compounds according to claim 1 of the general formulae (I) and (II) in which
R is A, Ar, A-Ar or A-Ar-A having a total of not more than 20 carbon atoms, where
A is a straight-chain or branched, saturated C₁-C₁₂-alkyl radical, cycloalkyl having 3-10 carbon atoms or C₄-C₂₀-cycloalkyl which is bonded via one or two alkyl group(s),
Ar is mono- or polysubstituted or unsubstituted phenyl, where substituents can adopt the meanings of A, and R has a total of not more than 20 carbon atoms,
R′, independently of the position in the molecule, is a straight-chain or branched, saturated C₁-C₇-alkyl radical,
R3 is A with the meaning of a straight-chain, unbranched (linear), branched, saturated, mono- or polyunsaturated or cyclic saturated, mono- or polyunsaturated hydrocarbon radical having 1-18 carbon atoms or of an aromatic hydrocarbon radical having from 6 to 18 carbon atoms which is unsubstituted or substituted by Z =A,
R1 and R2, independently of one another, are H, Cl, Br, or a straight-chain, branched, saturated, mono- or polyunsatuated C ₁-C₇-alkyl radical,
R4 is C₁-C₆-alkyl, C₅-C₈-cycloalkyl or C₆-Clo-aryl,
R5 and R6 are Ci-C₆-alkyl, C₅-C₈-cycloalkyl or C₆-C₁₀-aryl,
X is Cl or Br,
Z is A and
n is0,
and A and Ar are as defined in claim 1

4. Compounds according to claim 1 of the general formulae (I) and (II) in which
R is C₁-C₁₂-alkylene, C₃-C₁₀-cycloalkylene, or C₄-C₂₀-cycloalkylene, C₆-C₁₄-arylene or C₇-C₂₀-alkylarylene which is bonded via one or two alkyl group(s),
R′ is methyl, ethyl, propyl, i-propyl, butyl, i-butyl, sec-butyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-, methylpropyl (—C₆H₁₂—), 1-ethyl-2-methylpropyl (—C₆H₁₂—), 1,1,2- or 1,2,2-trimethylpropyl (—C₆H₁₂—), heptyl, octyl, nonyl, decyl, undecyl, dodecyl, vinyl, propenyl, 1,2-propadienyl, butenyl, butadienyl, pentenyl, 1,2-, 1,4- orl,3-pentadienyl, 2,3-dimethyl-2-butenyl, hexenyl, 1,5-hexadienyl, 2-methyl-1,3-butadienyl, 2,3-dimethyl-1,3-butadienyl, isopentenyl, cyclopropenyl, cyclobutenyl, cyclopentenyl, cyclopentadienyl, methylcyclopentadienyl, ethynyl, 1,2-propynyl, 2-butynyl, 1,3-butadiynyl, pentynyl or hexynyl,
R3 is phenyl, tolyl, 2,6-dimethylphenyl, mesityl, 2,6-diisopropylphenyl, 2,4,6-triisopropylphenyl or cyclohexyl,
R1 and R2 are SO3H, F. Cl, hydroxyl, alkanoyl or cycloalkanoyl,
R4 is methyl, ethyl, propyl, i-propyl, butyl, i-butyl, sec-butyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methylpropyl (—C₆H₁₂—), 1-ethyl-2-methylpropyl (—C₆H₁₂—), 1,1,2- or 1,2,2-trimethylpropyl (—C₆H₁₂—), cyclopentyl, cyclohexyl, methylcyclopentyl, cycloheptyl, methylcyclohexyl, cyclooctyl, phenyl, o-, m- or p-tolyl, o-, m- or p-ethylphenyl, o-, m- or p-propylphenyl, o-, m- or p-isopropylphenyl, o-, m- or p-tert-butylphenyl or naphthyl,
R5 and R6 are methyl, ethyl, propyl, i-propyl, butyl, i-butyl, sec-butyl, tert-butyl, pentyl, 1-, 2- or 3-methylbutyl (—C₅H₁₀—), 1,1-, 1,2- or 2,2-dimethylpropyl (—C₅H₁₀—), 1-ethylpropyl (—C₅H₁₀—), hexyl (—C₆H₁₂—), 1-, 2-, 3- or 4-methylpentyl (—C₆H₁₂—), 1,1-, 1,2-, 1,3-, 2,2-, 2,3- or 3,3-dimethylbutyl (—C₆H₁₂—), 1- or 2-ethylbutyl (—C₆H₁₂—), 1-ethyl-1-methyl-propyl (—C₆H₁₂—), 1-ethyl-2-methylpropyl (—C₆H₁₂—), 1,1,2- or 1,2,2-trimethylpropyl (—C₆H₁₂—), heptyl, octyl, nonyl, decyl, cyclopropenyl, cyclobutenyl, cyclopentenyl, cyclohexenyl, cyclopentadienyl and methylcyclopentadienyl, phenyl, o-, m- or p-tolyl, o-, m- or p-ethylphenyl, o-, m- or p-propylphenyl, o-, m- or p-isopropylphenyl, o-, m- or p-tert-butylphenyl, naphthyl, vinyl, propenyl, butenyl, pentenyl or hexenyl, ethynyl, propynyl, butynyl, pentynyl or hexynyl, where X, Z and n can adopt the meanings given in claim 1.

5. Compounds according to claim 1 of the general formulae (I) and (II) in which
R is methylene, ethylene, propylene, butylene, —C₆H₄—, —C₆H₂Me₂—, —CH₂C₆H₄—, —CH₂C₆H₂Me₂—, —CH₂C₆H₄CH₂— or —CH₂C₆H₂Me₂CH₂—,
R′ is methyl, ethyl, propyl, i-propyl, butyl, i-butyl, sec-butyl or tert-butyl,
R³ is phenyl, tolyl, 2,6-dimethylphenyl, mesityl, 2,6-diisopropylphenyl, 2,4,6-triisopropylphenyl or cyclohexyl,
R1 and R2, independently of one another, are H, methoxy, ethoxy, propionyl, butyryl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl or octadecanoyl,
R4 is cyclohexyl, cyclopentyl, isopropyl or phenyl,
R5 and R6 are H, methyl, phenyl, vinyl, —C=CMe₂ or —C=CPh₂,
X is Cl or Br,
Z is A and
n is0.

6. Compounds according to claim 1 of the general formulae (I) and (II) in which
R is methyl, ethyl, propyl, butyl or 2,4-dimethyl,
R′ is ethyl or methyl,
R3 is methyl, i-propyl, t-butyl, mesityl, phenyl, cyclohexyl, 2,4-(di-i-propyl)phenyl or 2,4-dimethylphenyl,
R1 and R2 are H,
R4 is cyclohexyl or phenyl,
R5 and R6 are phenyl, cyclohexyl or -C=C(CH₃)₂,
X is Cl or Br, and
n is 0.

7. {1-[3-(Triethoxysilyl)ethyl]-3-[2,4-(di-i-propyl)phenyl]imidazol-2-ylidene}[P(Cy)₃]Cl₂Ru=CHPh {1-[3-(trimethoxysilyl)ethyl]-3-[2,4-(di-i-propyl)phenyl]imidazol-2-ylidene}[P(Cy)₃]Cl₂Ru=CHPh {1-[3-(triethoxysilyl)propyl]-3-[2,4-(di-i-propyl)phenyl]imidazol-2-ylidene}[P(Cy)₃]Cl₂Ru=CHPh {1-[3-(trimethoxysilyl)propyl]-3-[2,4-(di-i-propyl)phenyl]imidazol-2-ylidene}[P(Cy)₃]Cl₂Ru=CHPh {1-[3-(triethoxysilyl)butyl]-3-[2,4-(di-i-propyl)phenyl]imidazol-2-ylidene}[P(Cy)₃]Cl₂Ru=CHPh {1-[3-(trimethoxysilyl)butyl]-3-[2,4-(di-i-propyl)phenyl]imidazol-2-ylidene}[P(Cy)₃]Cl₂Ru=CHPh {1-[3-(triethoxysilyl)ethyl]-3-(mesityl)imidazol-2-ylidene}[P(Cy)₃]Cl₂Ru=CHPh {1-[3-(trimethoxysilyl)ethyl]-3-(mesityl)imidazol-2-ylidene}[P(Cy)₃]Cl₂Ru=CHPh {1-[3-(triethoxysilyl)propyl]-3-(mesityl)imidazol-2-ylidene}[P(Cy)₃]Cl₂Ru=CHPh {1-[3-(trimethoxysilyl)propyl]-3-(mesityl)imidazol-2-ylidene}[P(Cy)₃]Cl₂Ru=CHPh {1-[3-(triethoxysilyl)butyl]-3-(mesityl)imidazol-2-ylidene}[P(Cy)₃]Cl₂Ru=CHPh {1-[3-(trimethoxysilyl)butyl]-3-(mesityl)imidazol-2-ylidene}[P(Cy)₃]Cl₂Ru=CHPh {1-[3-(triethoxysilyl)ethyl]-3-(phenyl)imidazol-2-ylidene}[P(Cy)₃]Cl₂Ru=CHPh {1-[3-(trimethoxysilyl)ethyl]-3-(phenyl)imidazol-2-ylidene}[P(Cy)₃]Cl₂Ru=CHPh {1-[3-(triethoxysilyl)propyl]-3-(phenyl)imidazol-2-ylidene}[P(Cy)₃]Cl₂Ru=CHPh {1-[3-(trimethoxysilyl)propyl]-3-(phenyl)imidazol-2-ylidene}[P(Cy)₃]Cl₂Ru=CHPh {1-[3-(triethoxysilyl)butyl]-3-(phenyl)imidazol-2-ylidene}[P(Cy)₃]Cl₂Ru=CHPh {1-[3-(trimethoxysilyl)butyl]-3-(phenyl)imidazol-2-ylidene}[P(Cy)₃]Cl₂Ru=CHPh {1-[3-(triethoxysilyl)ethyl]-3-(cyclohexyl)imidazol-2-ylidene}[P(Cy)₃]Cl₂Ru=CHPh {1-[3-(trimethoxysilyl)ethyl]-3-(cyclohexyl)imidazol-2-ylidene}[P(Cy)₃]Cl₂Ru=CHPh {1-[3-(triethoxysilyl)propyl]-3-(cyclohexyl)imidazol-2-ylidene}[P(Cy)₃]Cl₂Ru=CHPh {1-[3-(trimethoxysilyl)propyl]-3-(cyclohexyl)imidazol-2-ylidene}[P(Cy)₃]Cl₂Ru=CHPh {1-[3-(triethoxysilyl)butyl]-3-(cyclohexyl)imidazol-2-ylidene}[P(Cy)₃]Cl₂Ru=CHPh {1-[3-(trimethoxysilyl)butyl]-3-(cyclohexyl)imidazol-2-ylidene}[P(Cy)₃]Cl₂Ru=CHPh {1-[3-(triethoxysilyl)ethyl]-3-(t-butyl)imidazol-2-ylidene}[P(Cy)₃]Cl₂Ru=CHPh {1-[3-(trimethoxysilyl)ethyl]-3-(t-butyl)imidazol-2-ylidene}[P(Cy)₃]Cl₂Ru=CHPh {1-[3-(triethoxysilyl)propyl]-3-(t-butyl)imidazol-2-ylidene}[P(Cy)₃]Cl₂Ru=CHPh {1-[3-(trimethoxysilyl)propyl]-3-(t-butyl)imidazol-2-ylidene}[P(Cy)₃]Cl₂Ru=CHPh {1-[3-(triethoxysilyl)butyl]-3-(t-butyl)imidazol-2-ylidene}[P(Cy)₃]Cl₂Ru=CHPh {1-[3-(trimethoxysilyl)butyl]-3-(t-butyl)imidazol-2-ylidene}[P(Cy)₃]Cl₂Ru=CHPh {1-[3-(triethoxysilyl)ethyl]-3-(i-propyl)imidazol-2-ylidene}[P(Cy)₃]Cl₂Ru=CHPh {1-[3-(trimethoxysilyl)ethyl]-3-(i-propyl)imidazol-2-ylidene}[P(Cy)₃]Cl₂Ru=CHPh {1-[3-(triethoxysilyl)propyl]-3-(i-propyl)imidazol-2-ylidene}[P(Cy)₃]Cl₂Ru=CHPh {1-[3-(trimethoxysilyl)propyl]-3-(i-propyl)imidazol-2-ylidene}[P(Cy)₃]Cl₂Ru=CHPh {1-[3-(triethoxysilyl)butyl]-3-(i-propyl)imidazol-2-ylidene}[P(Cy)₃]Cl₂Ru=CHPh {1-[3-(trimethoxysilyl)butyl]-3-(i-propyl)imidazol-2-ylidene}[P(Cy)₃]Cl₂Ru=CHPh {1-[3-(triethoxysilyl)ethyl]-3-(methyl)imidazol-2-ylidene}[P(Cy)3]Cl₂Ru=CHPh {1-[3-(trimethoxysilyl)ethyl]-3-(methyl)imidazol-2-ylidene}[P(Cy)3]Cl₂Ru=CHPh {1-[3-(triethoxysilyl)propyl]-3-(methyl)imidazol-2-ylidene}[P (C y)3]Cl₂Ru=CHPh {1-[3-(trimethoxysilyl)propyl]-3-(methyl)imidazol-2-ylidene}[P(Cy)₃]Cl₂Ru=CHPh {1-[3-(triethoxysilyl)butyl]-3-(methyl)imidazol-2-ylidene}[P(Cy)₃]Cl₂Ru=CHPh {1-[3-(trimethoxysilyl)butyl]-3-(methyl)imidazol-2-ylidene}[P(Cy)₃]Cl₂Ru=CHPh {1-[4-(trimethoxysilyl)benzyl]-3-(mesityl)imidazol-2-ylidene}[P(Cy)₃]Cl₂Ru=CHPh {1-[4-(triethoxysilyl)benzyl]-3-(mesityl)imidazol-2-ylidene}[P(Cy)₃]Cl₂Ru=CHPh {1-[4-(trimethoxysilyl)benzyl]-3-(cyclohexyl)imidazol-2-ylidene}[P(Cy)₃]Cl₂Ru=CHPh {1-[4-(triethoxysilyl)benzyl]-3-(cyclohexyl)imidazol-2-ylidene}[P(Cy)3]Cl₂Ru=CHPh {1-[4-(trimethoxysilyl)benzyl]-3-(methyl)imidazol-2-ylidene}[P(Cy)₃]Cl₂Ru=CHPh {1-[4-(triethoxysilyl)benzyl]-3-(methyl)imidazol-2-ylidene}[P(Cy)₃]Cl₂Ru=CHPh {1-[4-(trimethoxysilyl)benzyl]-3-(phenyl)imidazol-2-ylidene}[P(Cy)₃]Cl₂Ru=CHPh {1-[4-(triethoxysilyl)benzyl]-3-(phenyl)imidazol-2-ylidene}[P(Cy)₃]Cl₂Ru=CHPh {1-[4-(trimethoxysilyl)benzyl]-3-(i-propyl)imidazol-2-ylidene}[P(Cy)₃]Cl₂Ru=CHPh {1-[4-(triethoxysilyl)benzyl]-3-(i-propyl)imidazol-2-ylidene}[P(Cy)₃]Cl₂Ru=CHPh {1-[4-(trimethoxysilyl)benzyl]-3-(t-butyl)imidazol-2-ylidene}[P(Cy)₃]Cl₂Ru=CHPh {1-[4-(triethoxysilyl)benzyl]-3-(t-butyl)imidazol-2-ylidene}[P(Cy)₃]Cl₂Ru=CLHPh {1-[4-(trimethoxysilyl)benzyl]-3-[2,4-(di-i-propyl)phenyl]imidazol-2-ylidene}[P(Cy)₃]Cl₂Ru=CHPh {1-[4-(triethoxysilyl)benzyl]-3-[2,4-(di-i-propyl)phenyl]imidazol-2-ylidene}[P(Cy)₃]Cl₂Ru=CHPh {1-[4-(trimethoxysilyl)-2,4-(dimethyl)phenyl]-3-(mesityl)imidazol-2-ylidene}[P(Cy)₃]Cl₂Ru=CHPh {1-[4-(triethoxysilyl)-2,4-(dimethyl)phenyl]-3-(mesityl)imidazol-2-ylidene}[P(Cy)₃]Cl₂Ru=CHPh {1-[4-(trimethoxysilyl)-2,4-(dimethyl)phenyl]-3-(cyclohexyl)imidazol-2-ylidene}[P(Cy)₃]Cl₂Ru=CHPh {1-[4-(triethoxysilyl)-2,4-(dimethyl)phenyl]-3-(cyclohexyl)imidazol-2-ylidene}[P(Cy)₃]Cl₂Ru=CHPh as well as {1-[3-(triethoxysilyl)ethyl]-3-[2,4-(di-i-propyl)phenyl]imidazolin-2-ylidene}[P(Cy)₃]Cl₂Ru=CHPh {1-[3-(trimethoxysilyl)ethyl]-3-[2,4-(di-i-propyl)phenyl]imidazolin-2-ylidene}[P(Cy)₃]Cl₂Ru=CHPh {1-[3-(triethoxysilyl)propyl]-3-[2,4-(di-i-propyl)phenyl]imidazolin-2-ylidene}[P(Cy)₃]Cl₂Ru=CHPh {1-[3-(trimethoxysilyl)propyl]-3-[2,4-(di-i-propyl)phenyl]imidazolin-2-ylidene}[P(Cy)₃]Cl₂Ru=CHPh {1-[3-(triethoxysilyl)butyl]-3-[2,4-(di-i-propyl)phenyl]imidazolin-2-ylidene}[P(Cy)₃]Cl₂Ru=CHPh {1-[3-(trimethoxysilyl)butyl]-3-[2,4-(di-i-propyl)phenyl]imidazolin-2-ylidene}[P(Cy)₃]Cl₂Ru=CHPh {1-[3-(triethoxysilyl)ethyl]-3-(mesityl)imidazolin-2-ylidene}-[P(Cy)₃]Cl₂Ru=CHPh {1-[3-(trimethoxysilyl)ethyl]-3-(mesityl)imidazolin-2-ylidene}[P(Cy)₃]Cl₂Ru=CHPh {1-[3-(triethoxysilyl)propyl]-3-(mesityl)imidazolin-2-ylidene}[P(Cy)₃]Cl₂Ru=CHPh {1-[3-(trimethoxysilyl)propyl]-3-(mesityl)imidazolin-2-ylidene}[P(Cy)₃]Cl₂Ru=CHPh {1-[3-(triethoxysilyl)butyl]-3-(mesityl)imidazolin-2-ylidene}[P(Cy)₃]Cl₂Ru=CHPh {1-[3-(trimethoxysilyl)butyl]-3-(mesityl)imidazolin-2-ylidene}[P(Cy)₃]Cl₂Ru=CHPh {1-[3-(triethoxysilyl)ethyl]-3-(phenyl)imidazolin-2-ylidene}[P(Cy)₃]Cl₂Ru=CHPh {1-[3-(trimethoxysilyl)ethyl]-3-(phenyl)imidazolin-2-ylidene}[P(Cy)₃]Cl₂Ru=CHPh {1-[3-(triethoxysilyl)propyl]-3-(phenyl)imidazolin-2-ylidene}[P(Cy)₃]Cl₂Ru=CHPh {1-[3-(trimethoxysilyl)propyl]-3-(phenyl)imidazolin-2-ylidene}[P(Cy)₃]Cl₂Ru=CHPh {1-[3-(triethoxysilyl)butyl]-3-(phenyl)imidazolin-2-ylidene}[P(Cy)₃]Cl₂Ru=CHPh {1-[3-(trimethoxysilyl)butyl]-3-(phenyl)imidazolin-2-ylidene}[P(Cy)₃]Cl₂Ru=CHPh {1-[3-(triethoxysilyl)ethyl]-3-(cyclohexyl)imidazolin-2-ylidene}[P(Cy)₃]Cl₂Ru=CHPh {1-[3-(trimethoxysilyl)ethyl]-3-(cyclohexyl)imidazolin-2-ylidene}[P(Cy)₃]Cl₂Ru=CHPh {1-[3-(triethoxysilyl)propyl]-3-(cyclohexyl)imidazolin-2-ylidene}[P(Cy)₃]Cl₂Ru=CHPh {1-[3-(trimethoxysilyl)propyl]-3-(cyclohexyl)imidazolin-2-ylidene}[P(Cy)₃]Cl₂Ru=CHPh {1-[3-(triethoxysilyl)butyl]-3-(cyclohexyl)imidazolin-2-ylidene}[P(Cy)₃]Cl₂Ru=CHPh {1-[3-(trimethoxysilyl)butyl]-3-(cyclohexyl)imidazolin-2-ylidene}[P(Cy)₃]Cl₂Ru=CHPh {1-[3-(triethoxysilyl)ethyl]-3-(t-butyl)imidazolin-2-ylidene}[P(Cy)₃]Cl₂Ru=CHPh {1-[3-(trimethoxysilyl)ethyl]-3-(t-butyl)imidazolin-2-ylidene}[P(Cy)₃]Cl₂Ru=CHPh {1-[3-(triethoxysilyl)propyl]-3-(t-butyl)imidazolin-2-ylidene}[P(Cy)₃]Cl₂Ru=CHPh {1-[3-(trimethoxysilyl)propyl]-3-(t-butyl)imidazolin-2-ylidene}[P(Cy)₃]Cl₂Ru=CHPh {1-[3-(triethoxysilyl)butyl]-3-(t-butyl)imidazolin-2-ylidene}[P(Cy)₃]Cl₂Ru=CHPh {1-[3-(trimethoxysilyl)butyl]-3-(t-butyl)imidazolin-2-ylidene}[P(Cy)₃]Cl₂Ru=CHPh {1-[3-(triethoxysilyl)ethyl]-3-(i-propyl)imidazolin-2-ylidene}[P(Cy)₃]Cl₂Ru=CHPh {1-[3-(trimethoxysilyl)ethyl]-3-(i-propyl)imidazolin-2-ylidene}[P(Cy)₃]Cl₂Ru=CHPh {1-[3-(triethoxysilyl)propyl]-3-(i-propyl)imidazolin-2-ylidene}[P(Cy)₃]Cl₂Ru=CHPh {1-[3-(trimethoxysilyl)propyl]-3-(i-propyl)imidazolin-2-ylidene}[P(Cy)₃]Cl₂Ru=CHPh {1-[3-(triethoxysilyl)butyl]-3-(i-propyl)imidazolin-2-ylidene}[P(Cy)₃]Cl₂Ru=CHPh {1-[3-(trimethoxysilyl)butyl]-3-(i-propyl)imidazolin-2-ylidene}[P(Cy)₃]Cl₂Ru=CHPh {1-[3-(triethoxysilyl)ethyl]-3-(methyl)imidazolin-2-ylidene}[P(Cy)₃]Cl₂Ru=CHPh {1-[3-(trimethoxysilyl)ethyl]-3-(methyl)imidazolin-2-ylidene}[P(Cy)₃]Cl₂Ru=CHPh {1-[3-(triethoxysilyl)propyl]-3-(methyl)imidazolin-2-ylidene}[P(Cy)₃]Cl₂Ru=CHPh {1-[3-(trimethoxysilyl)propyl]-3-(methyl)imidazolin-2-ylidene}[P(Cy)₃]Cl₂Ru=CHPh {1-[3-(triethoxysilyl)butyl]-3-(methyl)imidazolin-2-ylidene}[P(Cy)₃]Cl₂Ru--CHPh {1-[3-(trimethoxysilyl)butyl]-3-(methyl)imidazolin-2-ylidene}[P(Cy)₃]Cl₂Ru=CHPh {1-[4-(trimethoxysilyl)benzyl]-3-(mesityl)imidazolin-2-ylidene}[P(Cy)₃]Cl₂Ru=CHPh {1-[4-(triethoxysilyl)benzyl]-3-(mesityl)imidazolin-2-ylidene}[P(Cy)₃]Cl₂Ru=CHPh {1-[4-(trimethoxysilyl)benzyl]-3-(cyclohexyl)imidazolin-2-ylidene}[P(Cy)₃]Cl₂Ru=CHPh {1-[4-(triethoxysilyl)benzyl]-3-(cyclohexyl)imidazolin-2-ylidene}[P(Cy)₃]Cl₂Ru=CHPh {1-[4-(trimethoxysilyl)benzyl]-3-(methyl)imidazolin-2-ylidene}[P(Cy)₃]Cl₂Ru=CHPh {1-[4-(triethoxysilyl)benzyl]-3-(methyl)imidazolin-2- ylidene}[P(Cy)₃]Cl₂Ru=CHPh {1-[4-(trimethoxysilyl)benzyl]-3-(phenyl)imidazolin-2-ylidene}[P(Cy)₃]Cl₂Ru=CHPh {1-[4-(triethoxysilyl)benzyl]-3-(phenyl)imidazolin-2-ylidene}[P(Cy)₃]Cl₂Ru=CHPh {1-[4-(trimethoxysilyl)benzyl]-3-(i-propyl)imidazolin-2-ylidene}[P(Cy)₃]Cl₂Ru=CHPh {1-[4-(triethoxysilyl)benzyl]-3-(i-propyl)imidazolin-2-ylidene}[P(Cy)₃]Cl₂Ru=CHPh {1-[4-(trimethoxysilyl)benzyl]-3-(t-butyl)imidazolin-2-ylidene}[P(Cy)₃]Cl₂Ru=CHPh {1-[4-(triethoxysilyl)benzyl]-3-(t-butyl)imidazolin-2-ylidene}[P(Cy)₃]Cl₂Ru=CHPh {1-[4-(trimethoxysilyl)benzyl]-3-[2,4-(di-i-propyl)phenyl]imidazolin-2-ylidene}[P(Cy)₃]Cl₂Ru=CHPh {1-[4-(triethoxysilyl)benzyl]-3-[2,4-(di-i-propyl)phenyl]imidazolin-2-ylidene}[P(Cy)₃]Cl₂Ru=CHPh {1-[4-(trimethoxysilyl)-2,4-(dimethyl)phenyl]-3-(mesityl)imidazolin-2-ylidene}[P(Cy)₃]Cl₂Ru=CHPh {1-[4-(triethoxysilyl)-2,4-(dimethyl)phenyl]-3-(mesityl)imidazolin-2-ylidene}[P(Cy)₃]Cl₂Ru=CHPh {1-[4-(trimethoxysilyl)-2,4-(dimethyl)phenyl]-3-(cyclohexyl)imidazolin-2-ylidene}[P(Cy)₃]Cl₂Ru=CHPh {1-[4-(triethoxysilyl)-2,4-(dimethyl)phenyl]-3-(cyclohexyl)imidazolin-2-ylidene}[P(Cy)₃]Cl₂Ru=CHPh.

8. Process for the preparation of compounds of the general formulae (I) and (II), characterised in that an alkoxysilyl-functionalised imidazolium salt of the general formula (III) 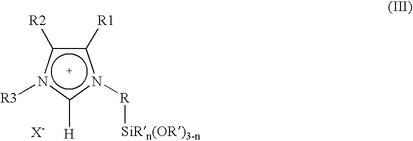
or an alkoxysilyl-functionalised 4,5-dihydroimidazolium salt of the general formula (IV) 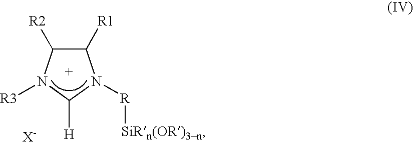
in which R, R′, R1, R2 and R3 may adopt the meanings given in the preceding claims, and X⁻ can be an anion from the group consisting of F⁻, Cl₋, Br⁻ and I⁻, is either converted directly into a compound of the general formula (I) or (II) respectively 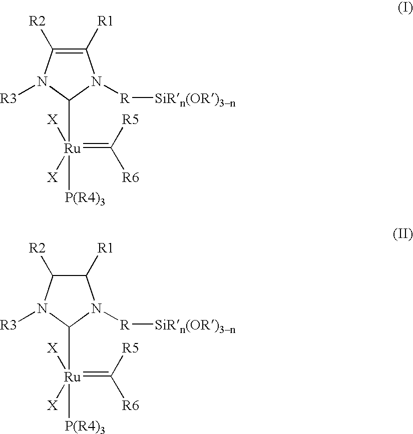
by reacting the compounds of the general formula (III) or (IV) with a base capable of deprotonation selected from the group consisting of the metal alkoxides (MOR), metal hydrides (MH), metal amides (MNH2) and/or ammonia in the presence of a compound of the general formula (X)
[P(R4)₃]₂X₂Ru=CR5R6 (X),
in which R4, R5, R6 and X are as in claim 1, in an anhydrous, inert, aprotic, organic solvent, or in that the compounds of the general formula (III) or (IV), if necessary after prior purification, are reacted with a base selected from the group consisting of the metal alkoxides (MOR), metal hydrides (MH), metal amides (MNH2) and/or ammonia in an anhydrous, inert, aprotic, organic solvent to give carbenes of the general formula (V) or (VI) respectively 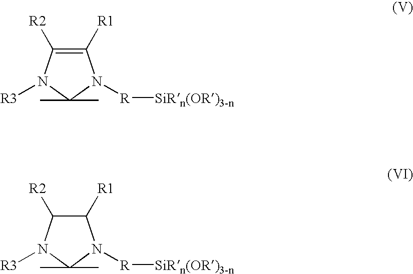
and are subsequently reacted with compounds of the general formula (X)
[P(R4)₃]₂X₂Ru=CR5R6 (X)
in an anhydrous, inert, aprotic, organic solvent under a protective-gas atmosphere to give compounds of the general formula (I) or (II) respectively.

9. Process according to claim 8, characterised in that the compound of the general formula (III) or (IV), the base employed and the ruthenium compound of the general formula (X) are employed in a stoichiometric ratio in the range from 1:1:1 to 1:1.5:1.5, where the ratio of the base employed to the ruthenium compound is independent of one another.

10. Process according to claim 8, characterised in that KO^{t}butoxide or KH is employed as base.

11. Process according to claim 8, characterised in that the solvents used are hydrocarbons or ethers.

12. Process according to claim 8, characterised in that, for the reaction of the compound of the general formula (III) or (IV) with a ruthenium compound of the general formula (X) in the presence of a base, a solvent selected from the group consisting of pentane, hexane, heptane, octane, decane, benzene, toluene and tetrahydrofuran or mixtures thereof is used.

13. Process according to claim 8, characterised in that the reaction of the compound of the general formula (III) or (IV) with a ruthenium compound of the general formula (X) is carried out over the course of from 30 minutes to two days at a temperature in the range from −78 to +150°C., where the protective gas used is nitrogen or argon.

14. Process according to claim 8, characterised in that the reaction of the compound of the general formula (V) or (VI) with a ruthenium compound of the general formula (X) is carried out in a solvent selected from the group consisting of pentane, hexane, heptane, octane, decane, benzene, toluene and tetrahydrofuran.

15. Process according to claim 8, characterised in that the reaction of carbene of the general formula (V) or (VI) with a ruthenium compound of the general formula (X) is carried out in a stoichiometric ratio of between 1:1 and 1:1.5.

16. Process according to claim 8, characterised in that the reaction is carried out over the course of from 30 minutes to two days at a temperature in the range from −78 to +100° C.

17. Use of the compounds of the general formulae (I) and (II) as catalysts in organic and organometallic synthesis.

18. Use of the compounds of the general formulae (I) and (II) as starting materials for the preparation of immobilised catalysts for organic and organometallic syntheses.

19. Use of the compounds of the general formulae (I) and (II) as catalysts in C-C coupling reactions, hydrogenations, isomerisations, silylations and hydroformylations.

20. Use of the compounds of the general formulae (I) and (II) as catalysts in olefin metathesis reactions, such as cross metathesis (CM), ring closure metathesis (RCM), ring opening metathesis polymerisation (ROMP), acyclic diene metathesis polymerisation (ADMET) and ene-yne metathesis.
